(19) United States
(12) Patent Application Publication
(10) Pub. No.: US 2026/0270162 A1
(43) Pub. Date: Sep. 10, 2026

(54) NETWORK ASSISTED HANDLING OF AI/ML MODELS OR AI/ML FUNCTIONALITIES IN A USER DEVICE

(71) Applicant: FRAUNHOFER-GESELLSCHAFT ZUR FÖRDERUNG DER ANGEWANDTEN FORSCHUNG E.V., München (DE)

(72) Inventors: Tatiana RYKOV, Berlin (DE); Thomas FEHRENBACH, Berlin (DE); Baris GÖKTEPE, Berlin (DE); Thomas WIRTH, Berlin (DE); Thomas SCHIERL, Berlin (DE); Cornelius HELLGE, Berlin (DE); Thomas WIEGAND, Berlin (DE); Alvaro LÓPEZ RAVENTÓS, Berlin (DE); Buket TORUN, Berlin (DE)

(21) Appl. No.: 19/665,492

(22) Filed: May 1, 2026

Related U.S. Application Data
(63) Continuation of application No. PCT/EP2024/080539, filed on Oct. 29, 2024.

(30) Foreign Application Priority Data
Nov. 3, 2023 (EP) 23207645.5

(51) Int. Cl. H04L 41/16; G01S 19/25; H04B 17/318; H04W 64/00

(52) U.S. Cl. CPC H04L 41/16; G01S 19/25; H04B 17/328; H04W 64/00

(57) ABSTRACT

A user device, UE, for a wireless communication network is to use at least one Artificial Intelligence/Machine Learning model, AI/ML model, or at least one AI/ML functionality for performing one or more tasks. On the basis of certain information, the UE is to do one more of the following
determine one or more of the AI/ML models or AI/ML functionalities to be applicable by the UE, or
manage the use of the AI/ML models or AI/ML functionalities.

### CROSS-REFERENCE TO RELATED APPLICATIONS

This application is a continuation of copending International Application No. PCT/EP 2024/080539, filed Oct. 29, 2024, which is incorporated herein by reference in its entirety, and additionally claims priority from European Application No. EP 23207645.5, filed Nov. 3, 2023, which is also incorporated herein by reference in its entirety.

The present invention relates to the field of wireless communication systems or networks, more specifically a use of at least one Artificial Intelligence/Machine Learning model, AI/ML model, or at least one AI/ML functionality in a wireless communication system for performing one or more tasks. Embodiments of the present invention concern a network assisted handling of AI/ML models or AI/ML functionalities used for performing one or more tasks in a user device, UE.

### BACKGROUND OF THE INVENTION

FIG. 1 is a schematic representation of an example of a terrestrial wireless network 100 including, as is shown in FIG. 1(A), the core network, CN, 102 and one or more radio access networks RAN1, RAN2, . . . RANN. FIG. 1(B) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-family. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANn may include more or less such cells, and RANn may also include only one base station. FIG. 1(B) shows two users UE1 and UE2, also referred to as user device or user equipment, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. This may be realized on licensed bands or on unlicensed bands. Further, FIG. 1(B) shows two further devices 1101 and 1102 in cell 1064, like IoT devices, which may be stationary or mobile devices. The device 1101 accesses the wireless communication system via the base station gNB4 to receive and transmit data as schematically represented by arrow 1121. The device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB1 to gNB5 may be connected, e.g., via the S1 or X2 interface or the XN interface in NR, with each other via respective backhaul links 1161 to 1165, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1st-stage SCI, and optionally, a second control region which contains a second part of control information, also referred to as the 2nd-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB1 to gNB5, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

In a wireless network or communication system Artificial Intelligence (AI) and Machine Learning (ML) may be employed for certain tasks. For example, according to 3GPP, AI/ML techniques and data analytics may be incorporated into the 5G system design for supporting certain tasks, e.g., for supporting network automation, data collection for various network functions, network energy savings, load balancing, mobility optimizations, AI/ML-based services, AI/ML for the new radio (NR) air interface. For example, when considering the NR air interface, AI/ML models may be employed for one or more of the following use cases:

Channel State Information (CSI):

For example, AI/ML may be used for a time-domain prediction.

Beam Management (BM):

For example, AI for beam management in 5G involves the use of AI and ML techniques to improve the efficiency and reliability of a wireless communication using directional beams. Beam management is the process of steering, tracking, and selecting the best beams for each user and link in a 5G network. This is challenging due to factors such as user mobility, a higher number of antennas, and the adoption of elevated frequencies. AI and ML may offer valuable solutions to mitigate this complexity and minimize the overhead associated with beam management and selection, while maintaining system performance.

Unlicensed band operation:

For example AI for channel access in unlicensed bands for 5G involves the use of AI and ML techniques to improve the efficiency and reliability of wireless communication using the unlicensed spectrum. The unlicensed spectrum is the part of the radio frequency spectrum that is not allocated to any specific service or operator, and may be used by anyone who follows certain rules and regulations. The unlicensed spectrum may offer more bandwidth, lower cost, and greater flexibility for 5G applications, especially in scenarios where the licensed spectrum is scarce or expensive. There are some challenges and opportunities of AI for channel access in unlicensed bands for 5G, like:

Channel access methods: There are different methods for accessing unlicensed channels, such as listen before talk, LBT, gap-based channel access, contention-based random access, etc. Each method has its own advantages and disadvantages in terms of latency, throughput, fairness, and overhead. AI and ML may help to design, optimize, and adapt these methods according to the network conditions and user requirements.

Spectrum sharing and coexistence: The unlicensed spectrum is shared by multiple users and technologies, such as Wi-Fi, Bluetooth, LTE-U, LAA, MulteFire, CBRS, NR, etc. This may cause interference, congestion, and collisions among different transmissions. AI and ML may help to enhance the spectrum sharing and coexistence mechanisms, such as sensing, coordination, scheduling, power control, beamforming, etc., to improve the spectral efficiency and quality of service.

Private networks and industrial IoT: The unlicensed spectrum may enable the deployment of 5G private networks and industrial IoT applications, such as smart factories, warehouses, mines, etc. These applications have high demands for reliability, security, and low latency. AI and ML may help to customize and optimize the network performance for these applications, such as intelligent load balancing, proactive network slicing, anomaly detection, etc.

Positioning:

For example, a direct AI/ML positioning approach (e.g., fingerprinting) and an AI/ML assisted positioning approach (e.g., the output of the AI/ML model inference is an additional measurement and/or an enhancement of an existing measurement) may be implemented.

The AI/ML model may be running at one of the two sides or at both sides of the communication link, e.g., at the gNB or the network-side, e.g., CN, and/or at the UE. Some AI/ML models may not be specified and left up to implementation, while others, e.g., enabling AI/ML for the air interface, need to be specified.

It is noted that the information in the above section is only for enhancing the understanding of the background of the invention and, therefore, it may contain information that does not form prior art that is already known to a person of ordinary skill in the art.

Starting from the above, there may be a need for improvements or enhancements to the use of AI/ML models in a wireless communication system or network.

### SUMMARY

An embodiment may have auser device, UE, for a wireless communication network, wherein the UE is to use at least one Artificial Intelligence/Machine Learning model, AI/ML model, or at least one AI/ML functionality for performing one or more tasks, wherein, on the basis of certain information, the UE is to do one more of the following
determine one or more of the AI/ML models or AI/ML functionalities to be applicable by the UE, or
manage the use of the AI/ML models or AI/ML functionalities.

Another embodiment may have a network entity for a wireless communication network, wherein the network entity is to communicate with a user device, UE, of the wireless communication network, the UE using at least one Artificial Intelligence/Machine Learning model, AI/ML model, or at least one AI/ML functionality for performing one or more tasks, and wherein the network entity is to provide to the UE assistance information allowing the UE to determine one or more of the AI/ML models or AI/ML functionalities to be applicable by the UE, and/or to manage the use of the AI/ML models or AI/ML functionalities.

### Another Embodiment May Have a Wireless Communication Network, Like a 3rd Generation

Partnership Project, 3GPP, system, comprising a one or more inventive user devices, UEs, and/or one or more inventive network entities.

According to another embodiment, a method for operating a user device, UE, for a wireless communication network, wherein the UE is to use at least one Artificial Intelligence/Machine Learning model, AI/ML model, or at least one AI/ML functionality for performing one or more tasks, may have the steps of:
on the basis of certain information, doing one more of the following
determining one or more of the AI/ML models or AI/ML functionalities to be applicable by the UE, or
managing the use of the AI/ML models or AI/ML functionalities.

According to another embodiment, a method for operating a network entity for a wireless communication network, wherein the network entity is to communicate with a user device, UE, of the wireless communication network, the UE using at least one Artificial Intelligence/Machine Learning model, AI/ML model, or at least one AI/ML functionality for performing one or more tasks, may have the step of: providing to the UE assistance information allowing the UE to determine one or more of the AI/ML models or AI/ML functionalities to be applicable by the UE, and/or to manage the use of the AI/ML models or AI/ML functionalities.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1(A)-(B) illustrate a wireless communication network, wherein FIG. 1(A) is a schematic representation of an example of a terrestrial wireless network, and FIG. 1(B) is a schematic representation of an example of a radio access network, RAN;

FIG. 2 is a schematic representation of a system including a wireless communication network in which user devices, UEs, employ one or more AI/ML models;

FIG. 3 is a schematic representation of a wireless communication system including a transmitter, like a base station, and one or more receivers, like user devices, UEs, implementing embodiments of the present invention;

FIG. 4 illustrates a user device, UE, according to an embodiment of the present invention; and

FIG. 5 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

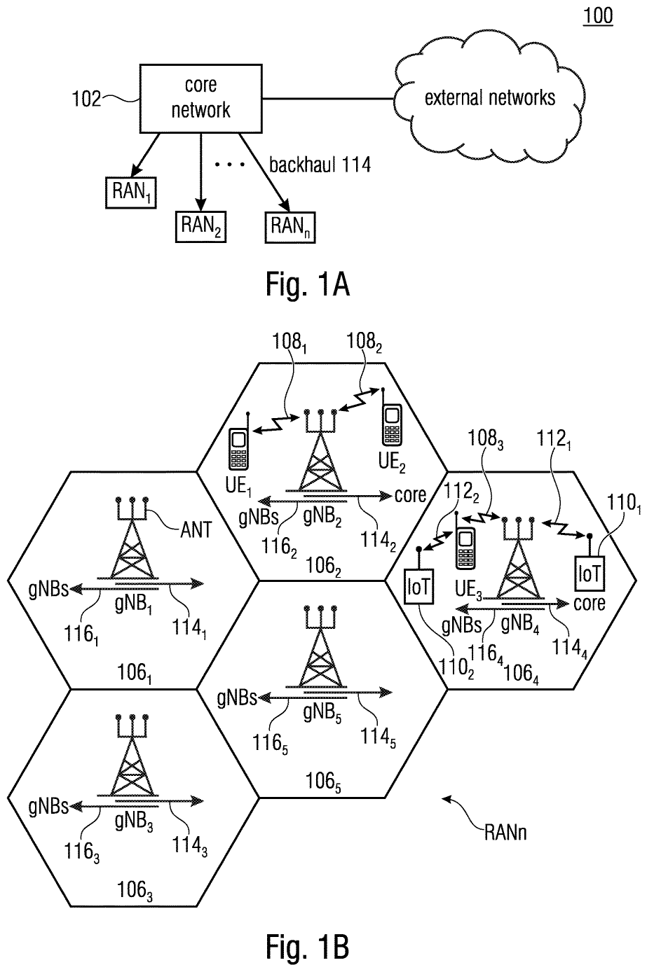

In a wireless communication system network, like the one described above with reference to FIG. 1, one or more Artificial Intelligence/Machine Learning models, AI/ML models, or one or more AI/ML functionalities may be implemented in a user device or user equipment, UE, for performing one or more tasks, e.g., one or more of the following:
AI/ML model based access to a RAN,
AI/ML model based network energy saving,
AI/ML model based load balancing,
AI/ML model based mobility optimization,
AI/ML model based use cases, like
channel state information, CSI, feedback, like a CSI compression and/or a CSI prediction, or
beam management, or
positioning, like a direct AI/ML positioning (e.g., fingerprinting) and/or an AI/ML assisted positioning,
AI/ML model based mobility management, e.g., a handover, HO, prediction and/or conditional handover, CHO, prediction,
AI/ML model based modulation and coding scheme, MCS, selection,
AI/ML model based synchronization,
AI/ML model based encoding and/or decoding and/or precoding,
AI/ML model based modulation and/or demodulation,
AI/ML model based positioning or ranging,
AI/ML model based joint communication and sensing, JSAC,
AI/ML model based feedback calculation, e.g., channel state information, CSI, channel quality indicator, CQI, preferred matrix index, PMI, rank indicator feedback,
AI/ML model based interference management,
AI/ML model based quality of experience, QoE, and/or quality of service, QoS, predictions,
AI/ML model based network traffic forecasting.

When implementing one or more AI/ML models or one or more AI/ML functionalities in a wireless communication network, like a 3GPP network or a WiFi network, the overall operation of the network or an efficiency of certain functions within the network may be improved. For example, the air interface in a 5G network may be enhanced using AI/ML. The respective AI/ML models when being implemented, for example within a user device, are trained on a basis of a training dataset, and the trained AI/ML model is used for performing a certain task. Further, the respective AI/ML models may be generalized. The generalization of an AI/ML model describes how it may adapt to new data, which is one of the key capabilities for evaluating the model's performance. For example, when considering a 3GPP wireless communication network, the following cases may be considered for verifying a generalization performance of an AI/ML model considering various scenarios/configurations:

### Case 1

The AI/ML model is trained based on a dataset from Scenario #A/Configuration #A, and then the AI/ML model performs an inference or test on a dataset for the same scenario/configuration, i.e., on a dataset for Scenario #A/Configuration #A.

### Case 2

The AI/ML model is trained based on dataset from a Scenario #A/Configuration #A, and then the AI/ML model performs an inference or test on a dataset different from Scenario #A/Configuration #A, for example on a dataset from Scenario #B/Configuration #B or from Scenario #A/Configuration #B.

### Case 3

The AI/ML model is trained based on a dataset constructed by mixing datasets from multiple scenarios/configurations including a first Scenario #A/Configuration #A and a second dataset different from the first scenario/configuration, for example, a dataset from Scenario #B/Configuration #B or Scenario #A/Configuration #B, and then the AI/ML model performs an inference or test on a dataset from a single scenario/configuration from the multiple scenarios/configurations, e.g., Scenario #A/Configuration #A, or Scenario #B/Configuration #B, or Scenario #A/Configuration #B.

It is noted that the number of multiple scenarios/configurations may be larger than 2. Also, ratio of dataset mixing may be reported.

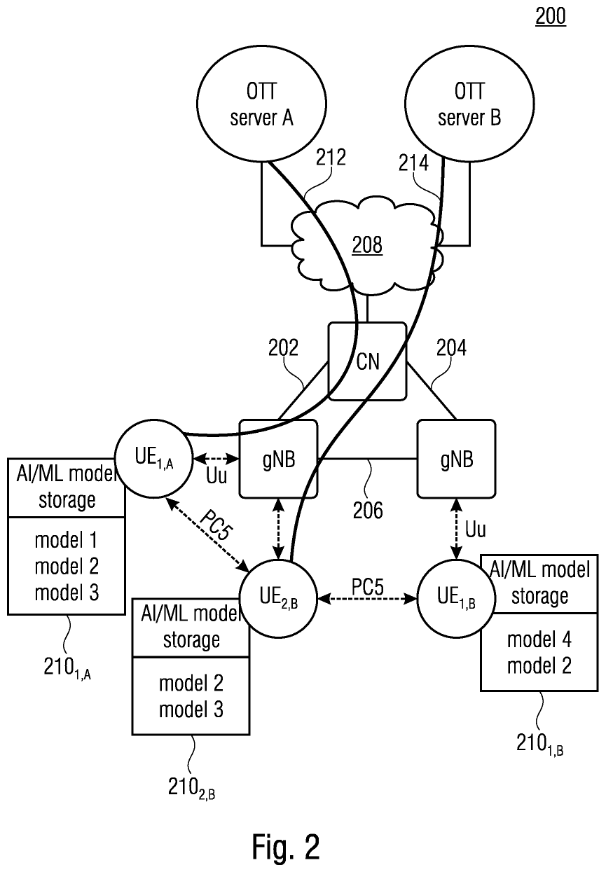

FIG. 2 is a schematic representation of a system 200 including a wireless communication network, like the one described above with reference to FIG. 1 in which the respective user devices, UEs, employ one or more AI/ML models. FIG. 2 illustrates a system including three UEs, namely UE1,A, UE1,B and UE2,B. The radio access network, RAN, includes two base stations gNB1 and gNB2 which are connected to the core network, CN, as is illustrated at 202 and at 204. Further, the base stations gNB1 and gNB2 are directly connected via a backhaul connection 206. The CN is connected, for example via a further network 208, like the Internet, to a first over the top, OTT, server A and to a second OTT server B. As is further illustrated, each of the UEs includes an AI/ML model storage 2101,A, 2101,B and 2102,B for storing respective AI/ML models or functionalities. In the system 200, UE1,A stores in its storage 2101,A three AI/ML models, namely Model 1, Model 2 and Model 3. UE1,A is connected via the Uu interface to the base station gNB1 and via the PC5 interface directly with UE2,B, for example, for performing a sidelink communication. UE2,B stores two AI/ML models, namely Model 2 and Model 3. UE2,B is also connected to the gNB1 via the Uu interface. Also, UE2,B is connected via the PC5 interface with UE1,B for a direct or a sidelink communication with UE1,B. UE1,B stores two AI/ML models, namely Model 2 and Model 4 and besides being connected via the PC5 interface UE2,B is also connected via the Uu interface to the gNB2. The OTT servers A, B provide the AI/ML models that may be used by the respective UEs. The UEs are connected via the RAN and the CN to the respective OTT servers so as to download the AI/ML models to be used at the respective UEs. In FIG. 2, UE1,A obtains the AI/ML models to be used from server A, as is schematically illustrated at 212. On the other hand, UE2,B receives the AI/ML models it is to use from server B, as is illustrated at 214. UE1,B may receive its AI/ML models from one or both of the servers A, B. Besides obtaining the respective AI/ML models, for example downloading them, the respective UEs are connected to the OTT servers A and B also for obtaining updates of the already stored AI/ML models.

Thus, in the system 200 a UE or a set of UEs is connected via a gNB to the core network, CN. The CN provides Internet connectivity to reach the over-the-top, OTT, servers, which may be from different providers. The UE receives AI/ML model updates or download AI/ML models from the OTT server through the control plane, CP, or through the user plane, UP. Two or more UEs may share one or more AI/ML models or may have different AI/ML models. The different AI/ML models may be mapped to the same or different tasks or functionalities, like mobility management, energy saving, etc.. Also, the same AI/ML models may be mapped to different tasks or functionalities or to the same task or functionality with different conditions, e.g., a Channel State Information, CSI, measurement, or for handling output conditions, like quantizer parameters, for a CSI compression use case. The AI/ML models may be stored on the OTT servers connected via the CN, or they may be stored within the CN, e.g., within one or more specific AI/ML network functions, NF, which are connected to the CN. In case of services being latency-critical or having localized functional requirements, such services may also be directly connected to a gNB or BS, e.g., via a local-IP breakout, for providing the AI/ML models. This is comparable to an edge-cloud server, which is configured by another operator, e.g., a 3rd party operator. The benefit of this is that more flexibility is introduced to the wireless communication network which allows new operators to introduce performance optimizations, e.g. reduce latency when downloading the AI/ML models.

The gNB or base station may be responsible for radio related functions in one or several cells, like measuring downlink signals and collecting measurement reports from UEs. A singular base station may measure any downlink signal originating from a neighboring base station. Hence, the base station may have extensive knowledge regarding the cell it is situated in as well as the cells adjacent to it. The gNB or base station may use its knowledge to train new AI/ML models, adapt existing ones or choose the most appropriate out of a set of AI/ML models and/or AI/ML functionalities. Performing these operations directly on the gNB or base station allows for a lower adaption or response time, which is required to adapt to changed conditions e.g., during handover procedure.

In a wireless communication network or in a system as depicted in FIG. 2, it may turn out that one or more AI/ML models or functionalities in a UE may not be well generalized for all use cases and deployment scenarios. Also, the limited storage capacity of the user equipment or UE may impose constraints on the number of models the UE is capable to store. Additionally, in certain specific use cases, it may be advantageous to utilize scenario-or configuration-specific AI/ML models. Conventionally, the storage management of AI/ML models or functionalities is carried out in a random or last-come/first-go or first-come/fist-go manner. For instance, when a UE is relocated or its environmental conditions change, it is possible for the AI/ML model, which yields the most favorable outcome under the present conditions, to be inadvertently deleted from the UE's storage area. Similarly, as the storage management is conducted independently of changing environmental conditions over the time, there is a risk of preventing achieving optimum performance by occupying unnecessary space with AI/ML models that are inoperable under the current conditions. As a result, it may be crucial to have efficient storage management for AI/ML models or functionalities to prevent inadequate resource allocation and enhance the performance optimization.

Therefore, there may be a need for improvements or enhancements with the handling of AI/ML models or AI/ML functionalities used for performing one or more tasks in a user device, UE.

Embodiments of the present invention address the above problem by providing a user device, UE, with network assistance for the handling of AI/ML models or AI/ML functionalities used for performing one or more tasks in a user device, UE. For example, based on assistance information from the network, NW, a UE may manage its storage capacity wisely, e.g., deleting low performing AI/ML models, while keeping the best ones. Thereby the UE's resources are utilized more effectively. Embodiments of the present invention provide a UE which is capable to use at least one AI/ML model or AI/ML functionality for performing certain tasks and that manages the use of the AI/ML model or AI/ML functionality responsive to certain information, like assistance data received from the NW or an AI zone. The user device, UE, for the wireless communication network, uses at least one AI/ML model or at least one AI/ML functionality for performing one or more tasks, and, on the basis of certain information, the UE determines one or more of the AI/ML models or AI/ML functionalities to be applicable by the UE, and/or manages the use of the AI/ML models or AI functionalities. Further embodiments of the present invention provide a network entity, like a further UE or a gNB, which provides assistance information to the inventive UE for allowing the UE to determine and/or manage the use of the AI/ML model or AI functionality. The network entity for the wireless communication network communicates with the user device, UE, which uses at least one AI/ML model or at least one AI/ML functionality for performing one or more tasks, for providing to the UE assistance information allowing the UE to determine one or more of the AI/ML models or AI/ML functionalities applicable by the UE, and/or to manage the use of the AI/ML models or AI/ML functionalities. In other words, embodiments of the present invention provide for an intelligent storage management and utilization of AI/ML models or AI/ML functionalities at the UE-side in at least some scenarios with the aid of assistance information provided by the NW.

The present invention is advantageous as it allows for a smart storage management of AI/ML models or functionalities, thereby overcoming the poor resource management as it is experienced in conventional approaches.

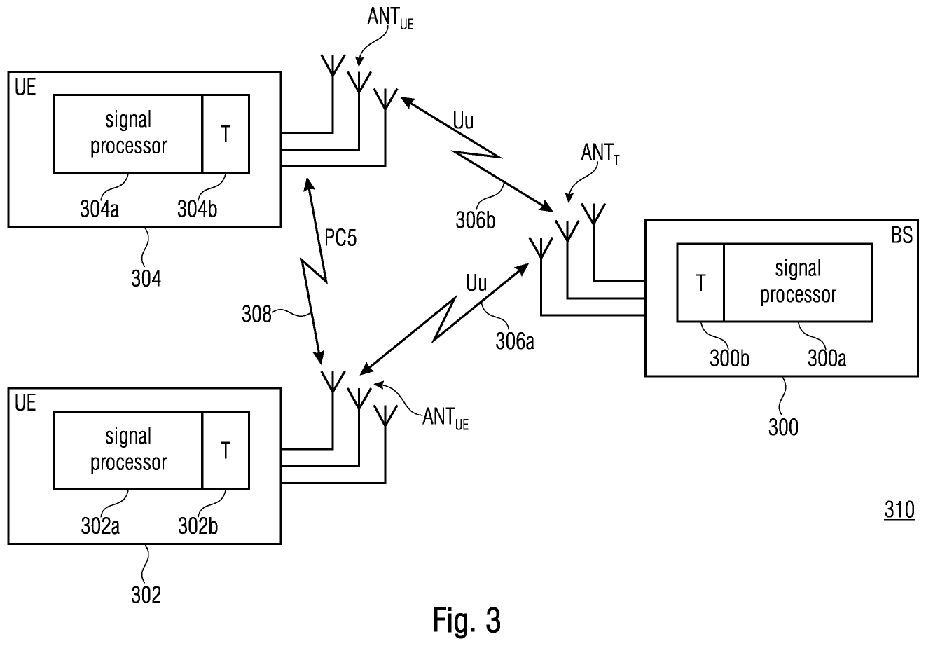

Embodiments of the present invention may be implemented in a wireless communication system as depicted in FIG. 1 including base stations and users, like mobile terminals or IoT devices. FIG. 3 is a schematic representation of a wireless communication system 310 including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANTT or an antenna array having a plurality of antenna elements, a signal processor 300a and a transceiver 300b, coupled with each other. The receivers 302, 304 include one or more antennas ANTUE or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

According to aspect 1 there is provided a user device, UE, for a wireless communication network,
wherein the UE is to use at least one Artificial Intelligence/Machine Learning model, AI/ML model, or at least one AI/ML functionality for performing one or more tasks,
wherein, on the basis of certain information, the UE is to do one more of the following determine one or more of the AI/ML models or AI/ML functionalities to be applicable by the UE, or manage the use of the AI/ML models or AI/ML functionalities.

According to aspect 2 relating to aspect 1, determining an applicability of an AI/ML model or AI/ML functionality comprise one or more of the following:
determining an AI/ML model or AI/ML functionality to be suitable,
determining an AI/ML model or AI/ML functionality to be used, or
determining an AI/ML model or AI/ML functionality to be cached

According to aspect 3 relating to aspect 1 or 2, the certain information comprises assistance information, and the UE is to do one or more of the following:
receive from one or more entities of the wireless communication network the assistance information, the assistance information allowing the UE to determine one or more of the AI/ML models or AI/ML functionalities suitable and/or to be used and/or to be cached for a certain UE condition,
manage the use of the AI/ML models or AI/ML functionalities according to the received assistance information, or
evaluate the performance of AI/ML models and AI/ML functionalities based on the assistance information provided by one or more entities of the wireless communication network.

According to aspect 4 relating to aspect 3, responsive to receiving the assistance information, the UE is to determine the one or more of the AI/ML models or AI/ML functionalities suitable or to be used or to be cached for the certain UE condition.

According to aspect 5 relating to aspect 3 or 4, the certain UE condition comprises one or more of the following:
a condition for a certain use case for which the UE is utilized, or
a condition for a certain scenario in which the UE is utilized, or
a condition at a certain site at which the UE is located, or
a certain gNB/NW configuration, or
a certain timestamp information, or
a certain frequency band, or
a certain UE internal capability, or
a certain UE configuration.

According to aspect 6 relating to any one of aspects 3 to 5, the certain UE condition comprises a current UE condition or an upcoming UE condition.

According to aspect 7 relating to any one of aspects 3 to 6, the assistance information includes
a signaling allowing the UE to determine the one or more AI/ML models or AI/ML functionalities to be applicable for the certain UE condition, or
information allowing the UE to determine the certain UE condition.

According to aspect 8 relating to aspect 7, the signaling
explicitly indicates, e.g., by AI/ML model or AI/ML functionality identifiers, the one or more AI/ML models or AI/ML functionalities to be applicable for the certain UE condition, or
indicates the certain UE condition and the UE is to determine on its own the one or more AI/ML models or AI/ML functionalities to be applicable for the certain UE condition.

According to aspect 9 relating to aspect 7 or 8, the signaling and/or the information
allowing the UE to determine the certain UE condition comprises one or more of the following:
information about a position of the UE,
information about communication conditions,
one or more measurement results.

According to aspect 10 relating to aspect 9, the information about a position of the UE comprises one or more of the following:
information about a geographical region or location where the UE is located, e.g.,
a communication range, like a distance from another entity of the wireless communication network device in terms of a minimum required communication range, MCR,
a location of the UE, e.g. GPS, GLONASS, BEIDOU, GALILEO,
information about the PLMN,
information about the paging area,
information about the tracking area,
information about the cell, beam,
information about neighboring Transmit/Receive Points (TRPs),
information about RAN-based Notification Area, RNA,
information about an AI zone or area,
information about a scenario in which the UE is employed, e.g.,
a scenario type, like urban, suburban, rural, indoors, outdoors, or
a cell type, like macro, micro, pico-cell, or
a UE density and distribution in the UE's environment.

According to aspect 11 relating to aspect 9 or 10, the information about communication conditions comprises one or more of the following:
information about a configuration of a site at which the UE is located, e.g.,
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE and a radio access network, RAN, of the wireless communication network, e.g.,
a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE and/or at a UE's communication partner, e.g.,
a beam direction, or
codebook information,
information about QoS conditions,
information about a cell load and/or a congestion.

According to aspect 12 relating to any one of aspects 9 to 11, the one or more measurement results comprise one or more of the following: performance measurements in the uplink and/or in the downlink, e.g., throughput measurements,
latency measurements,
packet delay measurements, like a propagation delay, a queueing delay or an access delay,
error rates and packet loss measurements,
resource utilization measurements,
jitter measurements,
mobility measurements, e.g.,
a number of handovers,
a number of inter-or intra-gNB handovers,
a Doppler spread of a received signal,
an angular spread of a received signal.

According to aspect 13 relating to any one of the preceding aspects, the UE is to
receive a signaling from the wireless communication network which indicates whether the UE is to employ a model-based life cycle management, LCM, operation or functionality-based LCM operation, or
decide on its own whether to employ a model-based life cycle management, LCM, operation or functionality-based LCM operation

According to aspect 14 relating to any one of the preceding aspects, the UE is to receive the certain information
responsive to a request by the UE, or
in a control or data signal, e.g., aperiodically or periodically, from the wireless communication network.

According to aspect 15 relating to aspect 14, a transfer of the certain information is requested by the UE or is triggered by the wireless communication network responsive to one or more criteria being fulfilled.

According to aspect 16 relating to aspect 15, the one or more criteria comprise one or more of the following:
one or more thresholds are exceeded, like a throughput threshold, a latency thresholds, or packet loss threshold,
a change in the UE condition,
one or more events occurred, like a change in a site or scenario or a change in a channel condition,
detection of a further UE via a sidelink, e.g., by decoding sidelink discovery messages transmitted via PC5.

According to aspect 17 relating to any one of the preceding aspects, the one or more entities of the wireless communication network comprise one or more of the following:
one or more further UEs with which the UE is to communicate directly, e.g., via a sidelink or a PC5 interface, or
one or more RAN entities, like a gNB, of the wireless communication network.

According to aspect 18 relating to any one of the preceding aspects, the UE is to inform one or more further UEs, directly or via a RAN entity, about the one or more of the AI/ML models or AI/ML functionalities used by the UE, e.g., responsive to detecting a newly added further UE in the UE's environment or responsive to a request from a further UE.

According to aspect 19 relating to any one of the preceding aspects, the UE is a member of a UE group including the UE and at least one further UE, and wherein the similar or identical certain information is provided for to UE group members.

According to aspect 20 relating to any one of the preceding aspects, the certain information is associated with a validity, and wherein the validity is signaled explicitly, e.g., together with the certain information, or is derived implicitly, e.g., as a time duration, like a number of slots or subframes or frames or OFDM symbols, or a location, like a geographical location, for/at which the certain information may be used by the UE.

According to aspect 21 relating to any one of the preceding aspects, the UE is to receive the different certain information form a plurality of entities of the wireless communication network, and wherein the UE is to associate a priority to the different certain information and consider the one of highest priority valid.

According to aspect 22 relating to aspect 21, the priority is determined based on one or more of the following:
a primary cell/cell group or secondary cell/cell group, e.g., prioritize the information from the primary cell/cell group,
an associated priority of a cell/gNB,
how recent the certain information is, e.g., value a last certain information more valid than an older one,
proximity and coverage area, e.g. UE may prioritize the information from the gNB that is closer in proximity or which provide better coverage,
roaming agreement, e.g. UE may prioritize information from gNB based on roaming agreements between operators or based on operator preferences,
a signal strength, RSSI, RSRP, SINR, SNR of a cell/cell group on which the certain information is received,
an explicitly signaled priority associated with the certain information,
a configured or preconfigured priority associated with the certain information.

According to aspect 23 relating to any one of the preceding aspects, for managing the use of the AI/ML models or AI/ML functionalities according to the received assistance information, the UE is to perform one or more of the following:
in case the one or more AI/ML models or AI/ML functionalities determined to be applicable for the certain UE condition are not yet stored in the UE, downloading, retraining fully or partially if necessary, storing and activating the one or more AI/ML models or AI/ML functionalities to be applicable for the certain UE condition,
in case the one or more AI/ML models or AI/ML functionalities determined to be applicable for the certain UE condition are stored in the UE, retraining if necessary and/or activating the one or more AI/ML models or AI/ML functionalities to be applicable for the certain UE condition,
deactivating AI/ML models or AI/ML functionalities stored in the UE and determined not to be applicable for the certain UE condition,
deactivating all AI/ML models or AI/ML functionalities stored in the UE and using conventional non-AI based methods for performing the one or more tasks,
removing from a UE storage, partly or completely, AI/ML models or AI/ML functionalities stored in the UE and determined not to be applicable for the certain UE condition.

According to aspect 24 relating to aspect 23, in case the certain UE condition comprises an upcoming UE condition, downloading the one or more AI/ML models or AI/ML functionalities comprises
downloading one or more parts of the one or more AI/ML models or AI/ML functionalities at a time prior to the UE assuming the upcoming UE condition, and
downloading remaining parts of the one or more AI/ML models or AI/ML functionalities at a time the UE assumed the upcoming UE condition.

According to aspect 25 relating to aspect 23 or 24, in case the UE determines a specific UE condition, for which one or more specific AI/ML models or AI/ML functionalities were determined to be applicable, to reoccur after the certain UE condition with a probability exceeding a threshold, the UE is to
remove from the UE storage one part of the one or more specific AI/ML models or AI/ML functionalities, and
maintain in the UE storage the rest of the one or more specific AI/ML models or AI/ML functionalities.

According to aspect 26 relating to any one of the preceding aspects, the upcoming UE condition comprises a condition at a site at which the UE is located after a handover, HO, or after a conditional handover, CHO.

According to aspect 27 relating to any one of the preceding aspects, the wireless communication network comprises one or more two-dimensional or three-dimensional zones,
the certain information identifies at least one predefined one of the zones, like an AI zone, and
when being within the predefined zone, the UE is to
determine one or more of the AI/ML models or AI/ML functionalities to be applicable while being in the predefined zone, and manage the use of the AI/ML models or AI/ML functionalities according to the predefined zone.

According to aspect 28 relating to aspect 27, the predefined zone comprises one or more of the following:
a single cell of the wireless communication network,
a group of cells of the wireless communication network,
a zone associated with a particular scenario, e.g., one or more urban microcells, UMi, or one or more urban macrocells, UMa, or one or more rural microcells, RMi, or one or more rural macrocells RMa, or indoors,
a specific district, e.g., one or more cities, or one or more regions, or one or more countries, or one or more continents,
a certain area or volume described by its outer geometric shape.

According to aspect 29 relating to aspect 27 or 28, each of the plurality of zones is identified by a unique identification.

According to aspect 30 relating to any one of aspects 27 to 29, two or more of the plurality of zones are grouped into a zone group, e.g., based on their similarities.

According to aspect 31 relating to any one of aspects 27 to 30, the predefined zone is valid for
a certain time, e.g., for a rush-hour in a city, or
a certain congestion scenario, e.g., for an air-space having a congestion kevel exceeding a threshold.

According to aspect 32 relating to any one of aspects 27 to 31, the predefined zone is defined by one or more of the following:
data of a global navigation satellite system, GNSS, e.g., GPS data, or GLONASS data, or Galileo data, or Beidou data,
a range of pathlosses between the UE and a radio access network, RAN, entity of the wireless communication network, like a gNB or a sidelink, SL, UE,
a communication range between the UE and a radio access network, RAN, entity of the wireless communication network, like a gNB or a sidelink, SL, UE,
a designated paging area data, including e.g., an area within which the UE is expected to be reachable by the network and can respond to the paging request,
a tracking area data, which consists e.g., of several cells grouped together for mobility management purposes,
a list or range of cell ids, e.g. PCIS
cellular or sidelink positioning techniques, e.g., by utilizing positioning reference symbols, like downlink positioning reference signals, DL-PRSs,
advanced MIMO techniques, e.g., by a correlation of beamformers.

According to aspect 33 relating to any one of aspects 27 to 32, the UE is to receive information allowing the UE to identify whether the UE is located in the predefined zone and the AI/ML models or AI/ML functionalities to be applicable by the UE in the predefined zone.

According to aspect 34 relating to aspect 33, the information is included in one or more of the following:
a system information message received at the UE, like a system information block, SIB, or a master information block, MIB.
one or more aperiodic or periodic transmissions by the wireless communication network received at the UE,
one or more transmissions by the wireless communication network received at the UE in response to a request by the UE,
one or more transmissions by the wireless communication network received at the UE in response to a HO or a CHO,
a CHO configuration as a condition and the UE is to perform the CHO only if the UE comprises one or more AI/ML models or AI/ML functionalities to be applicable in a target zone,
a configuration or in a pre-configuration with which the UE is configured or preconfigured, e.g., by the wireless communication network or by a server connected to the wireless communication,
in a specification of the wireless communication,
a roaming configuration, e.g., if the UE is not connected to its home public land mobile network, PLMN.

According to aspect 35 relating to any one of aspects 27 to 34, for managing the use of the AI/ML models or AI/ML functionalities according to the predefined zone, the UE is to perform before and/or after entering the predefined zone one or more of the following:
in case the one or more AI/ML models or AI/ML functionalities determined to be applicable for the predefined zone are not yet stored in the UE, downloading, retraining fully or partially if necessary, storing and activating the one or more AI/ML models or AI/ML functionalities to be applicable for the predefined zone,
in case the one or more AI/ML models or AI/ML functionalities determined to be applicable for the predefined zone are stored in the UE, retraining if necessary, activating the one or more AI/ML models or AI/ML functionalities to be applicable for the predefined zone,
deactivating AI/ML models or AI/ML functionalities stored in the UE and determined not to be applicable for the predefined zone,
deactivating all AI/ML models or AI/ML functionalities stored in the UE and using conventional non-AI based methods for performing the one or more tasks,
removing from a UE storage, partly or completely, AI/ML models or AI/ML functionalities stored in the UE and determined not to be applicable for the predefined zone.

According to aspect 36 relating to any one of the preceding aspects, the UE is to transmit a report about the management of the AI/ML models or AI/ML functionalities performed by the UE.

According to aspect 37 relating to any one of the preceding aspects, the UE is to
prioritize the one or more of the AI/ML models or AI/ML functionalities to be applicable, and
use the one or more of the AI/ML models or AI/ML functionalities according to the prioritization.

According to aspect 38 relating to aspect 37, the UE is to prioritize the one or more of the AI/ML models or AI/ML functionalities responsive to one or more of the following:
assistance information received from the wireless communication network,
one or more internal parameters of the UE,
one or more performance requirements to be fulfilled by the UE, e.g., achieving a low latency or obtaining an AI/ML model or AI/ML functionality performance exceeding a threshold,
one or more requirements and applicability conditions of the one or more AI/ML models or AI/ML functionalities.
one or more optimization reports from other UEs in the wireless communication network, priority list compiled by the UE or compiled and provided by the wireless communication network.

According to aspect 39 relating to aspect 38, the one or more internal parameters comprise one or more of the following:
the UE has a sufficient battery life for executing one or more of the AI/ML models or AI/ML functionalities,
the UE has a sufficient storage capacity for executing one or more of the AI/ML models or AI/ML functionalities,
the UE has sufficient AI/ML computational capabilities for executing one or more of the AI/ML models or AI/ML functionalities,
the UE has no hardware limitation for executing one or more of the AI/ML models or AI/ML functionalities, e.g., the UE is able to process one or more LCM operations for a specific model or functionality,
the UE is not of a certain device type, e.g., a RedCap device or an IoT device which may not have the required hardware capabilities for executing one or more of the AI/ML models or AI/ML functionalities.
the UE has no vendor information prohibiting the execution of one or more of the AI/ML models or AI/ML functionalities, e.g., certain AI/ML models or AI/ML functionalities may be specific to a particular vendor.
the UE is subscribed to the use of the one or more AI/ML models or AI/ML functionalities, e.g., the UE's subscription support specific AI/ML models or AI/ML functionalities.

According to aspect 40 relating to any one of the preceding aspects, the one or more of tasks comprise one or more of the following:
AI/ML model based access to a RAN,
AI/ML model based network energy saving,
AI/ML model based scheduling optimizations
AI/ML model based network slicing management,
AI/ML model based load balancing,
an AI/ML model based mobility optimization,
AI/ML model based use cases, like
channel state information, CSI, feedback, like a CSI compression and/or a CSI prediction, or
beam management, or
positioning, like a direct AI/ML positioning (e.g., fingerprinting) and/or an AI/ML assisted positioning,
AI/ML model based mobility management, e.g., a handover, HO, prediction and/or conditional handover, CHO, prediction,
AI/ML model based modulation and coding scheme, MCS, selection,
AI/ML model based synchronization,
AI/ML model based encoding and/or decoding and/or precoding,
AI/ML model based modulation and/or demodulation,
AI/ML model based positioning or ranging,
AI/ML model based joint communication and sensing, JSAC,
AI/ML model based feedback calculation, e.g., CSI/CQI/PMI/RI feedback,
AI/ML model based interference management,
AI/ML model based quality of experience, QoE, and/or quality of service, QoS, predictions,
AI/ML model based network traffic forecasting.

According to aspect 41 relating to any one of the preceding aspects, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

According to aspect 42 there is provided a network entity for a wireless communication network,
wherein the network entity is to communicate with a user device, UE, of the wireless communication network, the UE using at least one Artificial Intelligence/Machine Learning model, AI/ML model, or at least one AI/ML functionality for performing one or more tasks, and
wherein the network entity is to provide to the UE assistance information allowing the UE to determine one or more of the AI/ML models or AI/ML functionalities to be applicable by the UE, and/or to manage the use of the AI/ML models or AI/ML functionalities.

According to aspect 43 relating to aspect 42, the UE comprises a user device, UE, of any one of aspects 1 to 41.

According to aspect 44 relating to aspect 42 or 43, wherein the assistance information includes
a signaling allowing the UE to determine the one or more AI/ML models or AI/ML functionalities to be applicable for a certain UE condition, or
information allowing the UE to determine a certain UE condition

According to Aspect 45 Relating to Aspect 44, the Signaling
explicitly indicates, e.g., by AI/ML model or functionality identifiers, the one or more AI/ML models or AI/ML functionalities to be applicable by the UE for the certain UE condition, or
indicates the certain UE condition on the basis of which the UE is to determine on its own the one or more AI/ML models or AI/ML functionalities to be applicable by the UE for the certain UE condition.

According to aspect 46 relating to aspect 44 or 45, the information for determining the signaling and/or the information allowing the UE to determine the certain UE condition comprises one or more of the following:
information about a position of the UE,
information about communication conditions,
one or more measurement results.

According to aspect 47 relating to aspect 46, the information about a position of the UE comprises one or more of the following:
information about a geographical region or location where the UE is located, e.g.,
a communication range, like a distance from another entity of the wireless communication
network device in terms of a minimum required communication range, MCR,
a location of the UE, e.g. GPS, GLONASS, BEIDOU, GALILEO,
information about the home PLMN,
information about the paging area,
information about the cell, beam,
information about RAN-based Notification Area, RNA,
information about neighboring Transmit/Receive Points (TRPs),
information about an AI zone or area,
information about a scenario in which the UE is employed, e.g.,
a scenario type, like urban, suburban, rural, indoors, outdoors, or
a cell type, like macro, micro, pico-cell, or
a UE density and distribution in the UE's environment.

According to aspect 48 relating to aspect 46 or 47, the information about communication conditions comprises one or more of the following:
information about a configuration of a site at which the UE is located, e.g.,
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE and a radio access network, RAN, of the wireless communication network, e.g.,
a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE and/or at a UE's communication partner, e.g.,
a beam direction, or
codebook information,
information about QoS conditions,
information about a cell load and/or a congestion.

According to aspect 49 relating to any one of aspects 46 to 48, the one or more measurement results comprise one or more of the following:
performance measurements in the uplink and/or in the downlink, e.g.,
throughput measurements,
latency measurements,
packet delay measurements, like a propagation delay, a queueing delay or an access delay,
error rates and packet loss measurements,
resource utilization measurements,
jitter measurements,
mobility measurements, e.g.,
a number of handovers,
a number of inter- or intra-gNB handovers,
a Doppler spread of a received signal,
an angular spread of a received signal.

According to aspect 50 relating to any one of aspects 42 to 49, the network entity is to send to the UE a signaling which indicates whether the UE is to employ a model-based life cycle management, LCM, operation or functionality-based LCM operation.

According to aspect 51 relating to any one of aspects 42 to 50, the network entity is to provide the assistance information
responsive to a request from the UE, or
in a control or data signal, e.g., aperiodically or periodically.

According to aspect 52 relating to aspect 51, a transfer of the assistance information is triggered by the wireless communication network responsive to one or more criteria being fulfilled, wherein the to one or more criteria comprise, e.g., one or more of the following:
one or more thresholds are exceeded, like a throughput threshold, a latency thresholds, or packet loss threshold,
a change in the UE condition,
one or more events occurred, like a change in a site or scenario or a change in a channel condition,
detection of a further UE via a sidelink, e.g., by decoding sidelink discovery messages transmitted via PC5.

According to aspect 53 relating to any one of aspects 42 to 52, the network entity is provide similar or identical assistance information a UE group including the UE and at least one further UE.

According to aspect 54 relating to any one of aspects 42 to 53, the certain UE condition comprises one of the following:
a condition for a certain use case for which the UE is utilized, or
a condition for a certain scenario in which the UE is utilized, or
a condition at a certain site at which the UE is located, or
a certain gNB/NW configuration, or
a certain timestamp information, or
a certain frequency band, or
a certain UE internal capability, or
a certain UE configuration.

According to aspect 55 relating to any one of aspects 42 to 54, the certain UE condition comprises a current UE condition or an upcoming UE condition.

According to aspect 56 relating to any one of aspects 42 to 55, the network entity is to gather optimization reports from one or more further UEs for particular AI/ML models or AI/ML functionalities for different configurations, sites or scenarios, wherein the optimization report comprises supplementary information that represents a current condition of the further UE, like a performance evaluation of one or more AI/ML models or AI/ML functionalities employed by the further UE, and
extract from the one or more optimization reports information to be provided at least as part of the assistance information to the UE.

According to aspect 57 relating to any one of aspects 42 to 56, the network entity comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

According to aspect 58 there is provided a wireless communication network, like a 3rd Generation Partnership Project, 3GPP, system, comprising a one or more user devices, UEs, of any one of aspects 1 to 41 and/or one or more network entities of any one of aspects 42 to 57.

According to aspect 59 there is provided a method for operating a user device, UE, for a wireless communication network, wherein the UE is to use at least one Artificial Intelligence/Machine Learning model, AI/ML model, or at least one AI/ML functionality for performing one or more tasks, the methods comprising:
on the basis of certain information, doing one more of the following
determining one or more of the AI/ML models or AI/ML functionalities to be applicable by the UE, or
managing the use of the AI/ML models or AI/ML functionalities.

According to aspect 60 there is provided a method for operating a network entity for a wireless communication network, wherein the network entity is to communicate with a user device, UE, of the wireless communication network, the UE using at least one Artificial Intelligence/Machine Learning model, AI/ML model, or at least one AI/ML functionality for performing one or more tasks, the method comprising:
providing to the UE assistance information allowing the UE to determine one or more of the AI/ML models or AI/ML functionalities to be applicable by the UE, and/or to manage the use of the AI/ML models or AI/ML functionalities.

According to aspect 61 there is provided a non-transitory computer program product comprising a computer readable medium storing instructions which, when executed on a computer, perform the method of aspect 59 or 60.

The present invention provides a computer program product comprising instructions which, when the program is executed by a computer, causes the computer to carry out one or more methods in accordance with the present invention.

Embodiments of the present invention are now described in more detail with reference to the accompanying drawing. It is noted that the subsequently outlined and described aspects or embodiments may be combined such that some or all of the aspects/embodiments are implemented within one embodiment. Reference is made herein one or more AI/ML models and/or to one or more AI/ML functionalities. It is noted that when referring only to an AI/ML model, this is to be understood to refer also to an AI/ML functionality, and that when referring only to an AI/ML functionality, this it to be understood to refer also to an AI/ML model. AI/ML functionality may refer to an AI/ML-enabled Feature/Feature Group, FG, enabled by one or more configurations, where the one or more configurations may be supported based on one or more conditions indicated by a UE capability. An AI/ML-enabled Feature refers to a Feature where AI/ML may be used. It is noted that a UE may have one AI/ML model for the functionality, or the UE may have multiple AI/ML models for the functionality. Examples of use cases for AI/ML-enabled Features or Feature Groups are:

CSI feedback enhancement, e.g., overhead reduction, improved accuracy, prediction.

Beam management, e.g., beam prediction in time, and/or spatial domain for overhead and latency reduction, beam selection accuracy improvement.

Positioning accuracy enhancements for different scenarios including, e.g., those with heavy NLOS conditions.

Other examples may comprise of access to the RAN, network energy saving, NES, resource management and load balancing, scheduling optimizations, network slicing management, mobility enhancements and optimization including handover, HO, management and/or prediction, conditional handover, CHO, management and/or prediction, modulation and coding scheme, MCS, selection, MIMO precoder calculation, general PHY-layer signal processing, e.g., synchronization, channel coding or decoding, modulation or demodulation, positioning or ranging, joint communication and sensing, JSAC, feedback calculation of CSI/CQI or PMI/RI, general MIMO processing, equalization, interference management, quality of experience, QoE, and/or quality of service, QoS, predictions, and/or network traffic forecasting. It is noted that the AI/ML approaches for the selected sub use cases need to be diverse enough to support various requirements on the gNB-UE collaboration levels.

An AI/ML model operates based on identified models, where a model may be associated with one or more specific configurations/conditions associated with a UE capability of an AI/ML-enabled Feature/FG and additional conditions (e.g., scenarios, sites, and datasets) as determined/identified between the UE-side and the NW-side.

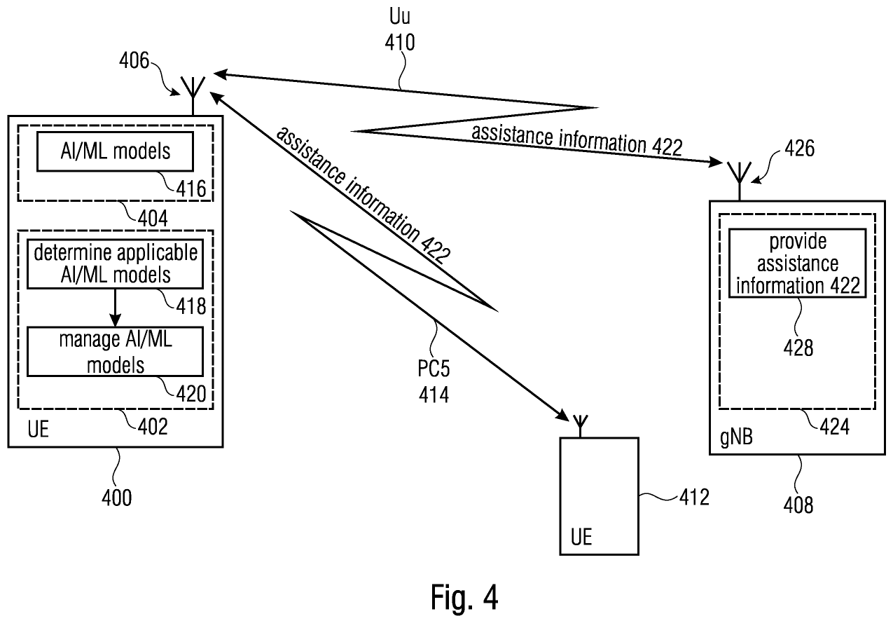

FIG. 4 illustrates a user device, UE, in accordance with embodiments of the present invention. The UE 400 includes a signal processing unit or signal processor 402, a storage or memory 404 and one or more antennas or an antenna array 406 for communicating with other network entities over the air interface. As is depicted in FIG. 4, the UE 400 may communicate with a base station or gNB 408 using the Uu interface 410 and/or with a further UE 412 using the PC5 interface 414 for a sidelink, SL, communication. As is schematically illustrated, the UE 400 is capable to use at least one Artificial Intelligence/Machine Learning model, AI/ML model, or at least one AI/ML functionality 416 for performing one or more tasks, which are stored in the UE's storage 404. On the basis of certain information, the UE 400 may determine the AI/ML models or AI/ML functionality to be applicable by the UE 400, as is illustrated at 418, and/or, again on the basis of the certain information, the UE 400 may manage the use of the AI/ML models or AI/ML functionalities as is illustrated at 420. The certain information, in accordance with embodiments, may comprise assistance information 422 provided to the UE 400 from the network side. For example the assistance information 422 may be provided by the gNB 408 and/or by the further UE 412 over the Uu interface 410 and over the PC5 interface 414, respectively. In accordance with other embodiments, the certain information may indicate a certain area or zone, and in case the UE 400 is within that certain area, which is also referred to herein as an AI zone or AI/ML zone, the UE 400 determines/manages AI/ML models or AI/ML functionality associated with the certain area. Thus, when the UE 400 receives the assistance information 422 and/or determines that it is located within a certain AI zone, the UE 400 may determine, for example from the assistance information 422, which AI/ML models are applicable. Also, on the basis of this information, the UE may manage the AI/ML models it currently holds.

In accordance with embodiments, when determining an applicability of an AI/ML model or AI/ML functionality, the UE 400, at 418, determines one or more AI/ML models or AI/ML functionalities which are suitable for the UE 400. For example, a suitable AI/ML model or functionality may be determined by the UE 400 if it is determined that a certain condition is given. For example, the UE may determine that, given its hardware requirements, it is able to execute a certain AI/ML model or functionality for a certain scenario within boundaries set by the network side, like an SNR range, a location in which the UE is located and the like. In accordance with other embodiments, for determining the applicability of the AI/ML, the UE 400 determines an AI/ML model or functionality to be used, for example in a situation in which the UE 400 expects to use the AI/ML model, like in the case of an upcoming handover or conditional handover. In accordance with yet other embodiments, the UE may determine AI/ML models to be cached or stored. This may refer to an actual cache activity, which involves actions related to managing which models are kept in the device memory and which are discarded to free some memory for other models to store. In accordance with other embodiments, this may also refer to a situation in which the UE 400 downloads or retrieves or prepares a certain AI/ML model or functionality that is suitable for a certain scenario or is to be used by the UE 400. Preparation may refer to optimizing or compiling a model for local execution (e.g. to efficiently run on an AI/ML accelerator). It may also refer to decompression or transformation of formats.

FIG. 4 further illustrates a network entity in accordance with embodiments of the present invention. The network entity may be a base station, like the gNB 408 or a further UE, like the UE 412. In the embodiment depicted in FIG. 4, the network entity is assumed to be the gNB 408, however, the subsequently described functionality may also be implemented in the UE 412. The gNB 408 comprises a signal processing unit 424 and one or more antennas or an antenna array 426. The gNB 408 communicates with the UE 400 over the Uu interface 410 and provides, as is indicated at 428, the assistance information 422 allowing the UE 400 to determine the applicable AI/ML models or functionalities and/or to manage the use thereof.

### NW Assistance Information

In the following, embodiments of the present invention are described in accordance with which the UE 400 receives the assistance information 422 from one or more of the other network entities, like the gNB 408 and/or the UE 412. In accordance with embodiments of the present invention, a broader network understanding is offered to the UE 400 by the base station or gNB 408 which enables the UE 400 to make informed choices regarding the AI/ML model or functionality to be stored and utilized in a particular use case or scenario or at a particular side or in case of a particular configuration. Consequently, this enhances the performance advantages of the UE-side AI/ML model or functionality. For example, if the UE 400 relocates or experiences a change in the environmental conditions, the network may share the assistance information 422 that is tailored to a certain configuration, to a certain scenario or to a certain side wherein the UE 400 is located. This allows the UE 400 to effectively manage the usage of the AI/ML models or functionalities by considering the current circumstances. By acquiring knowledge about the specific configuration, the UE 400 may make optimum decisions on how to use its resources on the basis of the assistance information 422 provided by the network.

In accordance with embodiments, the UE 400 receives the assistance information 422 which allows the UE 400 to determine one or more of the AI/ML models or AI/ML functionalities 418 which, for a certain UE condition, are suitable and/or may be used and/or may be cached. Alternatively or in addition, the UE 400 may manage the use of the AI/ML models or AI/ML functionalities 418 according to the received assistance information 422. The certain UE condition may include one or more of the following:
a condition for a certain use case for which the UE is utilized, or
a condition for a certain scenario in which the UE is utilized, or
a condition at a certain site at which the UE is located, or
a certain gNB/NW configuration. e.g. a beam pattern, a virtualization, a codebook, or
a certain timestamp information, e.g. a time of the day to allow different AI/ML models during day and night, rushhour or the like, or
a certain frequency band, e.g. an unlicensed or licensed supported by AI/ML models or AI/ML functionalities, or
a certain internal capability, e.g. a certain battery level or memory storage, or
a certain UE configuration.

It is noted that the certain UE condition may be a current UE condition or an upcoming UE condition. In accordance with embodiments, upcoming UE condition may be a condition at a site at which the UE is located after a handover, HO, or after a conditional handover, CHO. Thus, the assistance information may also be used to manage handovers or conditional handovers. By informing the UE 400 about the conditions of the candidate cell, the NW enables the UE 400 to take pre-emptive action in AI/ML model or AI/ML functionality management, such as AI/ML model/functionality activating, deactivating, switching, partial/complete retention and removing, prioritizing. Making decision on the AI/ML model management due to an environment change in a timely manner is advantageous as it prevents the decrease in performance that may occur due to delay of performing AI/ML model/functionality management decision only once the new condition applies.

In accordance with embodiments, the assistance information 422 may include explicit or implicit information about AI/ML models or functionalities to be used, or information allowing the UE to determine the UE condition. For example, the assistance information 422 may include:
a signaling allowing the UE to determine the one or more AI/ML models or AI/ML functionalities to be applicable for the certain UE condition, or
information allowing the UE to determine the certain UE condition.

In accordance with embodiments, the signaling explicitly indicates, e.g., by AI model or functionality identifiers, the one or more AI/ML models or AI/ML functionalities to be applicable for the certain UE condition. In accordance with other embodiments, the signaling indicates the certain UE condition so that the UE 400 is capable to determine on its own the one or more AI/ML models or AI/ML functionalities to be applicable.

The signaling and/or the information allowing the UE to determine the certain UE condition may include one or more of the following:

Information about a position of the UE, for example:
information about a geographical region or location where the UE is located, e.g.,
a communication range, like a distance from another entity of the wireless communication network device in terms of a minimum required communication range, MCR,
a location of the UE, e.g. GPS, GLONASS, BEIDOU, GALILEO,
information about the PLMN,
information about the paging area,
information about the tracking area,
information about the cell, e.g., using a physical cell ID, PCI, information about the beam,
information about neighboring Transmit/Receive Points (TRPs), e.g. gNBs, small cells, etc.,
information about RAN-based Notification Area, RNA,
information about an AI zone or area,
information about a scenario in which the UE is employed, e.g.,
a scenario type, like urban, suburban, rural, indoors, outdoors, or
a cell type, like macro, micro, pico-cell, or
a UE density and distribution in the UE's environment.

Information about communication conditions, for example
information about a configuration of a site at which the UE is located, e.g.,
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE and a radio access network, RAN, of the wireless communication network, e.g.,
a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE and/or at a UE's communication partner, e.g.,
a beam direction, or
codebook information,
information about QoS conditions,
information about a cell load and/or a congestion.

One or more measurement results, for example:
performance measurements in the uplink and/or in the downlink, e.g.,
throughput measurements,
latency measurements,
packet delay measurements, like a propagation delay, a queueing delay or an access delay,
error rates and packet loss measurements,
resource utilization measurements,
jitter measurements,
mobility measurements, e.g.,
a number of handovers,
a number of inter- or intra-gNB handovers,
a Doppler spread of a received signal which, for example, may be determined based on data receptions, reference signals, etc.
an angular spread of a received signal which, for example, may be determined based on data receptions, reference signals, etc..

In accordance with embodiments, the assistance information 422 may be used in different manners. The network side, e.g., gNB 408, may make decisions regarding the intelligent utilization of the UE's resources, like processing and memory capacities, based on certain pre-configured conditions or datasets, and then forward these decisions to the UE. 400 Alternatively, the UE 400 itself may optimize its decision-making process by leveraging the data provided by the network.

In the case the network makes the decision, there may be a defined or predefined lookup table at the network side. The table may contain AI/ML models or AI/ML functionalities that correspond to specific configured conditions, like the above UE conditions, or it may only include the configured conditions without specifying any AI/ML models or functionalities. Once the network acquires knowledge about the conditions for a particular cell, scenario, or site, either through the optimization reports, which are described later, from other users or measured metrics, the network forwards the assistance information 422, like information of the AI/ML model or AI/ML functionality that best matches the current conditions, to the UE 400. If there are no specific details about AI/ML models or AI/ML functionalities in the lookup table, the network may send assistance information 422 including only the current conditions or configured conditions that best matches the current conditions, allowing the UE 400 to make the decision. If the current conditions change, the network may inform the UE 400 about the model or functionality that best matches the new circumstances, and the UE 400 may choose to take a specific action, such as activating, deactivating, falling back, switching, retaining, or removing an AI/ML model or AI/ML functionality. After taking the action, the UE may or may not notify the network of its decision.

In accordance with embodiments, the UE 400 may apply a model-based or a functionality based life cycle management, LCM, for example responsive to an external signaling or by its own decision. For example, the UE 400 may receive a signaling from the wireless communication network which indicates whether the UE 400 is to employ a model-based LCM operation or a functionality-based LCM operation, or decide on its own whether to employ a model-based LCM operation or a functionality-based LCM operation. For example, the NW may establish a threshold for the LCM operations related to particular AI/ML models or functionalities, e.g., training (or fine-tunning) of an AI/ML model can be triggered by this threshold. The determination of whether to employ a model-based LCM or functionality-based LCM operation is prompted by this threshold. As mentioned, this decision may be made either at UE side or NW side. In accordance with embodiments, the NW may collect information regarding the data storage needs for a particular LCM objective. For example, a minimum input data size or type for, e.g., an inference or monitoring may be determined based on the experiences of other UEs at the given site or scenario. This may guarantee that the UE 400 has confidence in the selected AI/ML model operation, and that it will not be adversely affected by inadequate storage capacity, such as a lack of available storage space.

In accordance with embodiments, the assistance information 422 may be received by the UE 400 responsive to a request by the UE 400, or in a control or data signal that may be provided aperiodically or periodically by the wireless communication network. The control signal may include one or more of the following: the PDCCH, PSCCH, GC-PDCCH, SIB, MIB, PBCH, MAC CE, RRC, DCI, SCI or, for WiFi, SIG. The data signal may include one or more of the following: the PSSCH or the PDSCH. A request for the assistance information 422 by the UE 400 or a transfer of the assistance information 422 by the wireless communication network may be triggered responsive to one or more criteria being fulfilled. For example, the one or more criteria may include or more of the following:
one or more thresholds are exceeded, like a throughput threshold, a latency thresholds, or packet loss threshold,
a change in the UE condition,
one or more events occurred, like a change in a site or scenario or a change in a channel condition,
detection of a further UE via a sidelink, e.g., by decoding sidelink discovery messages transmitted via PC5.

In other words, the assistance data information may be transmitted to UE 400 through various methods. For example, the UE 400 may actively request the assistance data from NW (referred to as an active NW-assisted transfer), or the NW may proactively initiate the transfer of assistance data to the UE (referred to as a passive NW-assisted transfer). The transfer of the assistance information 422 may be triggered based on specific thresholds such as throughput, latency, or packet loss, as well as events such as changes in scenarios or channel conditions. The assistance information 422 may be provided periodically or as a one-time occurrence. With the assistance information 422 provided, the UE 400 may make decisions regarding the activation, deactivation, fallback, switching, retention, or removal of AI/ML models or functionalities.

In accordance with embodiments, the UE 400 may inform other UEs about the AI/ML it uses. For example, the UE 400 informs one or more further UEs, directly or via a RAN entity, about the one or more of the AI/ML models or AI/ML functionalities used by the UE, e.g., responsive to detecting a newly added further UE in the UE's environment or responsive to a request from a further UE. In other words, UEs may communicate with other UEs directly, e.g., via a sidelink/PC5, or via the NW to exchange their experiences regarding the current site, scenario, or configuration. For example, if a UE detects the presence of a newly added UE in the site, it may choose to directly share its own AI/ML model or functionality experience. The UE 400 may do this also in reply to a request from a newly added UE which requests this information from other UEs. Furthermore, a UE may detect another UE via sidelink, e.g., by decoding sidelink discovery messages transmitted via PC5, forward the information about the other UEs to the NW, and request similar assistance information 422, i.e., assistance information already provided to UEs in the same or similar condition.

In accordance with embodiments, the UE 400 may be a member of a group of UEs and receives group specific information. For example, when the UE 400 is a member of a UE group including the UE 400 and at least one further UE, similar or identical assistance information may be provided for all UE group members. For example, the NW may perform a user grouping and provide to a set of UEs or a group of UEs the similar or identical assistance information 422. Similar means that the same group of UE may be addressed with different information. For example, two UEs may be part of a same group, however, served by different beams or cells. Due to slightly different conditions, the gNB may provide different assistance information addressed to the same group, e.g. by using a group ID or a GC-PDCCH configuration, on different beams or cells. This allows efficient management of a large number of UEs by keeping the number of required groups low but still adapting the assistance information to the specific needs of a UE. This type of assistance information 422 may contain a group identifier, such that UEs may use this information to be aware of which group they belong to. The benefit is that this reduces signaling efforts in case a UE is aware of which group ID is linked to which assistance information 422. Further, UEs may exchange such information directly via the sidelink or indirectly via the NW, and may align or request for an alignment to the NW.

In accordance with embodiments, the assistance information 422 may be associated with a validity. The validity may be signaled explicitly, e.g., together with the assistance information 422, or it may be derived implicitly, e.g., as a time duration, like a number of slots or subframes or frames or OFDM symbols, or a location, like a geographical location, for/at which the certain information may be used by the UE 400.

In accordance with embodiments, the UE 400 may prioritize received assistance information 422. For example, the UE 400 may receive different assistance information 422 from a plurality of entities of the wireless communication network. The UE 400 associates a priority to the different assistance information 422 and considers the one of highest priority valid. The UE 400 may receive assistance information from multiple cells or gNBs. This assistance information may contradict each other, e.g., one gNB signals a rural scenario and another gNB signals a urban scenario. In such a case, the UE 400 associates a priority to the different assistance information and considers the one of highest priority valid. The priority may be determined based on one or more of the following:
a primary cell/cell group or secondary cell/cell group, e.g., prioritize the information from the primary cell/cell group,
an associated priority of a cell/gNB,
how recent the certain information is, e.g., value a last certain information more valid than an older one,
proximity and coverage area, e.g. UE may prioritize the information from the gNB that is closer in proximity or which provide better coverage,
roaming agreement, e.g. UE may prioritize information from gNB based on roaming agreements between operators or based on operator preferences,
a signal strength, RSSI, RSRP, SINR, SNR of a cell/cell group on which the certain information is received,
an explicitly signaled priority associated with the certain information,
a configured or preconfigured priority associated with the certain information.

The UE 400 may also compute a weighted average of some assistance information, e.g., performance measurement metrics, like throughput or latency, from multiple cells or gNBs and, based thereon, make decisions regarding the activation, deactivation, fallback, switching, retention, or removal of AI/ML models or functionalities.

In accordance with embodiments, the UE 400 may manage the use of the AI/ML models or AI/ML functionalities 418 according to the received assistance information as follows:

In case the one or more AI/ML models or AI/ML functionalities determined to be applicable for the certain UE condition are not yet stored in the UE 400, downloading, retraining fully or partially if necessary, storing and activating the one or more AI/ML models or AI/ML functionalities to be applicable for the certain UE condition.

In case the one or more AI/ML models or AI/ML functionalities determined to be applicable for the certain UE condition are stored in the UE 400, retraining if necessary and/or activating the one or more AI/ML models or AI/ML functionalities to be applicable for the certain UE condition,

Deactivating AI/ML models or AI/ML functionalities stored in the UE 400 and determined not to be applicable for the certain UE condition,

Deactivating all AI/ML models or AI/ML functionalities stored in the UE 400 and using conventional non-AI based methods for performing the one or more tasks,

Removing from a UE storage 404, partly or completely, AI/ML models or AI/ML functionalities stored in the UE 400 and determined not to be applicable for the certain UE condition. Some AI/ML models may share common parts and only differ in a second part, e.g. fine-tuning layers. Then, the UE 400 may discard some of these second parts, if it does not expect to use them soon and maintain the common part. This also has the benefit that only the second part has to be downloaded or trained, i.e. reducing the required data amount or training effort.

For an upcoming situation or condition, the UE 400 may download one or more parts of the one or more AI/ML models or AI/ML functionalities at a time prior to the UE assuming the upcoming UE condition, and download remaining parts of the one or more AI/ML models or AI/ML functionalities at a time the UE assumed the upcoming UE condition.

In accordance with embodiments, in case the UE 400 determines the a specific UE condition, for which one or more specific AI/ML models or AI/ML functionalities were determined to be applicable, reoccurs after the certain UE condition with a probability exceeding a threshold, the UE 400 is to
remove from the UE storage one part of the one or more specific AI/ML models or AI/ML functionalities, and
maintain in the UE storage the rest of the one or more specific AI/ML models or AI/ML functionalities.

In other words, with the NW provided assistance information available, the UE has the capability to assess the suitability of the one or more AI/ML models or AI/ML functionalities 416 stored in its system with respect to the specific UE conditions. The UE 400 may prefer to retain or activate the potential AI/ML models or AI/ML functionalities that yield the most favorable outcomes among others given the UE conditions, thereby optimizing its performance. There may be more than one AI/ML model defined under the same functionalities. The proposed mechanism allows the UE 400 to have the capability to assess the best performing AI/ML model in the given conditions for the targeted functionality. In accordance with further embodiments, if the potential one or more AI/ML models or functionalities are not available at the UE 400, the UE 400 may download the AI/ML model from the NW or from the OTT server transparently or non-transparently to 3GPP. In order to enhance a resource management efficiency, the UE 400 may consider storing a portion of the model within its repository or storage 404 and download the remaining segments when required. The UE 400 has the option to apply the partial downloading mechanism, making a strategic decision accordingly. In this case, partial downloading may be performed by downloading a partial AI/ML model from the NW. In another embodiment, a partial AI/ML model may also be obtained from another device, e.g., by transmitting is via a sidelink interface, e.g., a smartwatch having limited transmission capabilities may side-load an AI/ML model from a smartphone which may be closely located to the smartwatch. If the one or more AI/ML models or functionalities are not applicable, e.g., are not suitable or operable, for the particular configuration, site or scenario, the UE 400 may have the option to remove it from its storage 404 to make efficient use of its resources. The removal may be partially or completely. When the specific AI/ML model or AI/ML functionality meets the conditions of applicability, the UE may request the remaining or full AI/ML model/functionality. Thus, the assistance information provided by the NW may enable the UE 400 to efficiently and flexibly manage its storage capacity by allowing partial or complete retention or deletion of AI/ML models or functionalities in the storage space.

### AI Zones

In the following, further embodiments of the present invention are described in accordance with which the certain information on the basis of which the UE determines and/or manages AI/ML models comprises a certain area or zone, also referred to as AI zone. The certain information may indicate one or more AI zones, and the UE 400 may determine a location and whether it is located in one of the AI zones so as to determine/manage the AI/ML according to the configuration associated with the AI zone in which the UE is currently located.

In accordance with embodiments, the wireless communication network may include one or more two-dimensional or three-dimensional zones, referred to herein also as AI zones. Thus, an AI-zone may not be limited to UEs operating on the ground, e.g., in 2-D space, but may also be applied to UEs moving at different heights, e.g., UEs in high rise buildings, or to flying UEs, e.g., UAVs or planes. In this case, an AI-zone may have a 3-D component associated with it, such that different AI-zones may operate in different heights, which may result in AI-zone overlays.

The certain information or assistance information identifies at least one predefined one of the AI zones so that the UE 400, when being within the predefined zone, is capable to determine the one or more of the AI/ML models or AI/ML functionalities applicable while being in the predefined zone, and/or manage the use of the AI/ML models or AI/ML functionalities according to the predefined zone.

An AI zone may be comprised of a single cell or of a group of cells. Also, an AI zone may be associated with a particular scenario, such as an urban, a rural, or a suburban setting, as well as specific districts, cities, regions, countries, or continents. Each of the AI zones may have unique identification number. Also, the AI zones can be categorized into AI group zones based on their similarities, each with their own distinct IDs. For example, AI/ML models sharing a common part may be associated with the same AI group zone. Such group zones may be distinguished by characteristic features. There may be a correlation between the IDs of the AI zone and the AI group zone. Furthermore, AI zones and AI group zones may overlap. Thus, according to embodiments, the predefined zone may include one or more of the following:
a single cell of the wireless communication network,
a group of cells of the wireless communication network,
a zone associated with a particular scenario, e.g., one or more urban microcells, UMi, or one or more urban macrocells, UMa, or one or more rural microcells, RMi, or one or more rural macrocells RMa, or indoors,
a specific district, e.g., one or more cities, or one or more regions, or one or more countries, or one or more continents,
a certain area or volume described by its outer geometric shape.

The determination of the AI zone or AI zone group may be accomplished by utilizing GPS data, e.g., when a base station utilizes GPS-acquired parameters in a specific formula to calculate its AI zone or AI zone group. The present invention is not limited to such GPS data, in accordance with further embodiments, the predefined zone may be defined by one or more of the following:

Data of another global navigation satellite system, GNSS, e.g., GLONASS data, or Galileo data, or Beidou data.

A range of pathlosses between the UE and a radio access network, RAN, entity of the wireless communication network, like a gNB or a sidelink, SL, UE.

A communication range between the UE and a radio access network, RAN, entity of the wireless communication network, like a gNB or a sidelink, SL, UE.
a designated paging area data, including e.g., an area within which the UE is expected to be reachable by the network and can respond to the paging request,
a tracking area data, which consists e.g., of several cells grouped together for mobility management purposes,

A list or range of cell IDs, e.g. PCIs,

Cellular or sidelink positioning techniques, e.g., by utilizing positioning reference symbols, like downlink positioning reference signals, DL-PRSs. For example, some thresholds on the reference signals may be used, and the UE 400 considers itself in a certain region, if the received power, SNR, SINR of a certain reference signal lies within a certain range.

Advanced MIMO techniques, e.g., by a correlation of beamformers. For example, certain beams, based on their direction and strength, may define certain zones.

In another embodiment, an AI-zone may not be limited to UEs operating on the ground, e.g., in 2-D space, but may also be applied to UEs moving in different heights, e.g., UEs in high rise buildings, or applied to flying UEs, e.g., UAVs or planes. In this case, an AI-zone may have a 3-D component associated with it, such that different AI-zone may operate in different heights, e.g., which may result in AI-zone overlays. Finally, as already pointed out in a previous section, an AI-zone may be associated with a validity, e.g., it may be valid during a certain time of the day, e.g., rush-hour in a city, or a certain congestion scenario, e.g., a highly congested air-space.

In accordance with embodiments, an AI zone may be associated with a validity, e.g., it may be valid during a certain time of the day, e.g., rush-hour in a city, or a certain congestion scenario, e.g., a highly congested air-space.

The assistance information may include AI zone-related information such as the identification of the AI zone or group zone, specific AI/ML models or functionalities relevant to the situation, location or zone, as well as the applicable AI/ML models or functionalities in the given geographic area. It may also include parameters that enable the UE 400 to calculate its AI zone or group zone, along with any additional requirements for one or more particular AI/ML models or functionalities in specific zones. For example, different LCM purposes of a particular AI/ML model or functionality in the AI zone or AI group zone may have varying requirements, and it is advantageous to share this information with UE 400. Thus, the mentioned mechanism may share certain similarities with some broadcasting procedures carrying relevant information for the UE 400, e.g., the system information block, SIB or the master information block, MIB. Base stations may periodically broadcast information concerning the AI zone and/or the AI group zone, irrespective of the UE's preference. The UE 400 may request this information when required. For example, the information may be requested by the UE 400 prior to or subsequent to performing a handover process. Also, the AI zone-related information may be stored within a CHO configuration, and a UE may use this as a condition in order to perform a CHO. Instead of broadcasting the AI zone/group information, it may be configured or preconfigured by the network or the gNB or the OTT server or it may be provided by another UE or it may be fixed in the specification. It may also be part of a roaming configuration, e.g., in case a UE is not connected to its home PLMN. Thus, according to embodiments, the UE 400 uses the AI zone-related information to identify whether it is located in the predefined zone and the AI/ML models or AI/ML functionalities to be applicable by the UE in the predefined zone, and the AI zone-related information may be included in one or more of the following:
a system information message received at the UE, like a system information block, SIB, or a master information block, MIB.
one or more aperiodic or periodic transmissions by the wireless communication network received at the UE,
one or more transmissions by the wireless communication network received at the UE in response to a request by the UE,
one or more transmissions by the wireless communication network received at the UE in response to a HO or a CHO,
a CHO configuration as a condition and the UE is to perform the CHO only if the UE comprises one or more AI/ML models or AI/ML functionalities to be applicable in a target zone,
a configuration or in a pre-configuration with which the UE is configured or preconfigured, e.g., by the wireless communication network or by a server connected to the wireless communication,
in a specification of the wireless communication,
a roaming configuration, e.g., if the UE is not connected to its home public land mobile network, PLMN.

Thus, embodiments of the present invention allow the UE 400 to receive information, like the AI zone-related information, regarding required actions, e.g., actions both prior to and after a handover, even if it is not presently connected to the designated AI zone or AI group zone. Thus, in accordance with embodiments, for managing the use of the AI/ML models or AI/ML functionalities according to the predefined zone, the UE 400 may perform before and/or after entering the AI zone one or more of the following:
in case the one or more AI/ML models or AI/ML functionalities determined to be applicable for the predefined zone are not yet stored in the UE, downloading, retraining fully or partially if necessary, storing and activating the one or more AI/ML models or AI/ML functionalities to be applicable for the predefined zone,
in case the one or more AI/ML models or AI/ML functionalities determined to be applicable for the predefined zone are stored in the UE, retraining if necessary, activating the one or more AI/ML models or AI/ML functionalities to be applicable for the predefined zone,
deactivating AI/ML models or AI/ML functionalities stored in the UE and determined not to be applicable for the predefined zone,
deactivating all AI/ML models or AI/ML functionalities stored in the UE and using conventional non-AI based methods for performing the one or more tasks,
removing from a UE storage, partly or completely, AI/ML models or AI/ML functionalities stored in the UE and determined not to be applicable for the predefined zone.

The above embodiments are advantageous because potential adverse effects on a performance caused by delays in executing essential LCM functions, such as activation, deactivation, switching, delivery of one or more AI/ML models or functionalities in certain zones, may effectively be mitigated. Moreover, an overhead may be reduced by minimizing the need for control signaling between the UE and the NW. Also, an effective management of the UE storage is achieved by retaining/activating appropriate AI/ML models or functionalities and removing/deactivating unsuitable ones in certain zones.

In accordance with embodiments, the UE 400 may transmit a report about the management of the AI/ML models or AI/ML functionalities performed by the UE. For example, the UE 400 may report the taken actions to the NW. Furthermore, it may report the performance of the monitored AI/ML models, where the monitored AI/ML models are determined by the AI/ML management decisions.

### NW-Assisted Prioritization

In accordance with embodiments, the UE 400 may prioritize the one or more AI/ML models or functionalities. To establish a priority ranking, various factors, such as assistance information from the NW, resources available to the UE, requirements and applicability conditions of the AI/ML models or functions may be considered. The prioritization may be formed differently, depending on the overall UE's target when employing AI functionality, e.g., saving UE's internal capabilities (power, memory storage, etc.) or achieve low latency or obtain the most accurate AI model/functionality performance. Thus, the UE 400 may prioritize the one or more of the AI/ML models or AI/ML functionalities found to be applicable, and use the one or more of the AI/ML models or AI/ML functionalities according to the prioritization. The UE 400 may prioritize the one or more of the AI/ML models or AI/ML functionalities responsive to one or more of the following:

The assistance information received from the wireless communication network.

One or more internal parameters of the UE 400. For example:
the UE has a sufficient battery life for executing one or more of the AI/ML models or AI/ML functionalities,
the UE has a sufficient storage capacity for executing one or more of the AI/ML models or AI/ML functionalities,
the UE has sufficient AI/ML computational capabilities for executing one or more of the AI/ML models or AI/ML functionalities,
the UE has no hardware limitation for executing one or more of the AI/ML models or AI/ML functionalities, e.g., the UE is able to process one or more LCM operations for a specific model or functionality,
the UE is not of a certain device type, e.g., a RedCap device or an IoT device which may not have the required hardware capabilities for executing one or more of the AI/ML models or AI/ML functionalities.
the UE has no vendor information prohibiting the execution of one or more of the AI/ML models or AI/ML functionalities, e.g., certain AI/ML models or AI/ML functionalities may be specific to a particular vendor.
the UE is subscribed to the use of the one or more AI/ML models or AI/ML functionalities, e.g., the UE's subscription support specific AI/ML models or AI/ML functionalities.

One or more performance requirements to be fulfilled by the UE, e.g., achieving a low latency or obtaining an AI/ML model or AI/ML functionality performance exceeding a threshold.

One or more requirements and applicability conditions of the one or more AI/ML models or AI/ML functionalities, e.g., hardware requirements, a current load of the UE, a battery status/level, a temperature.

One or more optimization reports from other UEs in the wireless communication network. The optimization report may indicate the performance of AI/ML models or functionalities. This may be used to prioritize the AI/ML models or functionalities.

A priority list compiled by the UE or compiled and provided by the wireless communication network.

In accordance with further embodiments, based on the assistance information received from the NW, the UE 400 may determine it to be beneficial to prioritize the AI/ML model or functionality that produces the most favorable outcome in a given situation. The UE may compile a ranked list of AI/ML models or functionalities based on the assistance information such as optimization reports from other UEs. This list may be ordered from the best-performing AI/ML model or functionality to the one with the worst performance outcome under the given conditions. If the AI/ML model/functionality at the UE is known by the NW, the NW may also compile this list. This list may differ from the above mentioned priority list.

By applying the prioritization the UE 400 may efficiently address any negative impacts that its internal conditions may have on the performance and operational aspects of the AI/ML models or functionalities. For example, the UE may consider additional requirements of the AI/ML models or functionalities for each LCM objective. Consequently, the prioritization of AI/ML models or functionalities allows the UE to effectively manage its storage capacity and enhance the overall performance of the models or functionalities.

### Network Entity

As has been described above with reference to FIG. 4, embodiments of the present invention provide a network entity, like the gNB 408 or the further UE 412 for providing the assistance information 422 towards a UE, like the UE 400. The network entity obtains the above-described information for generating the assistance information 422 which is provided to the UE 400. Thus, at least some of the above-described operations may be performed at the network entity 408.

In accordance with embodiments, the gNB 408 may provide assistance information 422 which includes a signaling allowing the UE 400 to determine the one or more AI/ML models or AI/ML functionalities to be applicable for a certain UE condition, or information allowing the UE 400 to determine a certain UE condition. For example, the signaling may be explicit and indicates, e.g., by AI model or functionality identifiers, the one or more AI/ML models or AI/ML functionalities to be applicable by the UE 400 for the certain UE condition, or it may be implicit, e.g., by indicating the certain UE condition on the basis of which the UE 400 may determine on its own the one or more AI/ML models or AI/ML functionalities to be applicable by the UE 400 for the certain UE condition.

In accordance with embodiments, the gNB 408 may determine the signaling and/or the information using one or more of the following:

Information about a position of the UE 400.

For example, wherein the information about a position of the UE 400 may include one or more of the following:
information about a geographical region or location where the UE 400 is located, like
a communication range, like a distance from another entity of the wireless communication network device in terms of a minimum required communication range, MCR, or
a location of the UE 400, e.g. GPS, GLONASS, BEIDOU, GALILEO, or
information about the home PLMN, or
information about the paging area, or
information about the cell, beam, or
information about RAN-based Notification Area, RNA, or
information about neighboring Transmit/Receive Points (TRPs),
information about an AI zone or area,
information about a scenario in which the UE 400 is employed, like
a scenario type, like urban, suburban, rural, indoors, outdoors, or
a cell type, like macro, micro, pico-cell, or
a UE density and distribution in the UE's environment.

Information about communication conditions.

For example, the information about communication conditions may include one or more of the following:
information about a configuration of a site at which the UE 400 is located, like
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE 400 and a radio access network, RAN, of the wireless communication network, like
a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE 400 and/or at a UE's communication
partner, like
a beam direction, or
codebook information, or
information about QoS conditions, or
information about a cell load and/or a congestion.

One or more measurement results.

For example, the one or more measurement results may include one or more of the following:
performance measurements in the uplink and/or in the downlink, like
throughput measurements, or
latency measurements, or
packet delay measurements, like a propagation delay, a queueing delay or an access delay, or
error rates and packet loss measurements, or
resource utilization measurements,
jitter measurements,
mobility measurements, like
a number of inter- or intra-gNB handovers, or
a Doppler spread of a received signal, or
an angular spread of a received signal.

In accordance with embodiments, the gNB 408 may indicate to the UE 400, either via the assistance information 422 or via a separate signaling, whether the UE 400 is to employ a model-based life cycle management, LCM, operation or functionality-based LCM operation.

In accordance with embodiments, the gNB 408 may send or provide the assistance information 422 responsive to a request from the UE 400, or in a control or data signal, e.g., aperiodically or periodically. The transfer of the assistance information may be triggered responsive to one or more criteria being fulfilled, which may include one or more of the following:
one or more thresholds are exceeded, like a throughput threshold, a latency thresholds, or packet loss threshold,
a change in the UE 400 condition,
one or more events occurred, like a change in a scenario or a change in a channel condition,
detection of a further UE 4120 via a sidelink, e.g., by decoding sidelink discovery messages transmitted via PC5.

In accordance with embodiments, the gNB 408 may send or provide similar or identical assistance information 422 a UE group including the UE 400 and at least one further UE, like UE 412.

For generating the assistance information 422, the network entity may rely on information from other UEs or other network entities and compile information obtained from the various other network entities for providing and forwarding it as the assistance information 422 to the UE 400. In accordance with embodiments, the NW or network entity may gather optimization reports from other UEs for particular AI/ML models or functionalities for different configurations, sites or scenarios. These optimization reports may consist of supplementary information that represents the current conditions in which the other UE are positioned. Furthermore, these reports may contain a performance evaluation of the one or more AIML models or functionalities used by these other UE. The network entity may have limited or no awareness or knowledge regarding the specific AI/ML model employed to achieve a certain functionality and features and/or the specific details of the AI/ML models or functionalities, because an AI/ML model ID may not be globally unique. In this case, the NW may collect optimization reports for specific cases, e.g., functionality specific, use case specific from UEs in the current environment and share this information with other UEs. This information from the optimization reports enables the UE 400 to choose optimum AI/ML models or functionalities in a given environment and effectively handle functionality-based or model-based LCM operations. For example, it allows for the LCM operations e.g., activation, deactivation, fallback, and switching of AI/ML models or functionalities, as well as the retention or deletion of these AI/ML models or functionalities in certain conditions. The optimization reports, which involve monitoring the performance of specific AI/ML functionalities or AI/ML models in particular scenarios, sites or configurations, may be prepared either by the UE or by the NW if it has awareness of the models or functionalities at UE side.

The optimization report of AI/ML models may contain a huge amount of data, which, in turn, may result in a significant signaling overhead. To alleviate this burden, the UE or the NW may determine essential and valuable parameters for efficient AI/ML model storage 404 management and usage purposes.

Thus, according to embodiments, the network entity gathers the optimization reports from one or more further UEs for particular AI models or AI/ML functionalities for different configurations, sites or scenarios, wherein the optimization report comprises supplementary information that represents a current condition of the further UE, like a performance evaluation of one or more AI/ML models or AI/ML functionalities employed by the further UE, and extracts from the one or more optimization reports information to be provided at least as part of the assistance information to the UE.

### General

Embodiments of the present invention have been described in detail above, and the respective embodiments and aspects may be implemented individually or two or more of the embodiments or aspects may be implemented in combination.

Embodiments of the present invention have been described in above with reference to one or more UEs connected to a 5G/5G-Advanced CN, e.g., 5G standalone, SA, network. However, the present invention is not limited to such embodiments. In accordance with other embodiments, the one or more UEs may be connected to a 5G non-standalone, NSA, network. In case of a 5G non-standalone, NSA, connectivity, the inventive approach may be implemented via respective OTT-services as described above with reference to FIG. 2.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

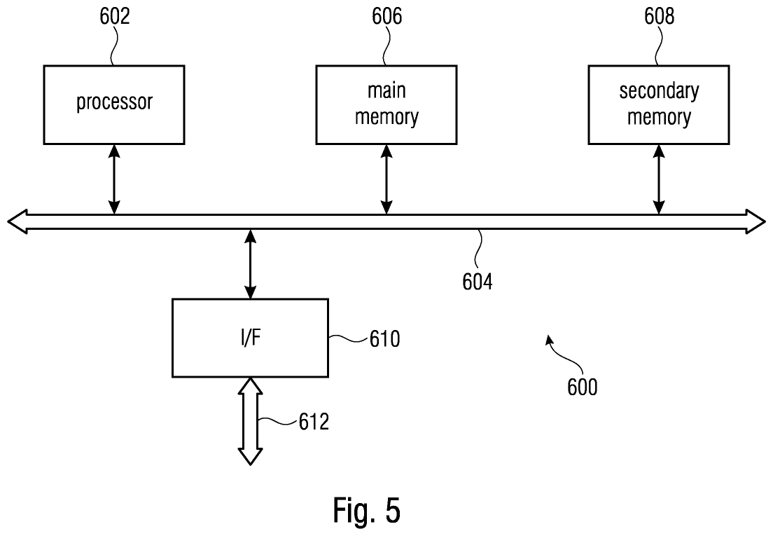

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 5 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network,
wherein the UE is to use at least one Artificial Intelligence/Machine Learning model, AI/ML model, or at least one AI/ML functionality for performing one or more tasks,
wherein, on the basis of certain information, the UE is to do one more of the following
determine one or more of the AI/ML models or AI/ML functionalities to be applicable by the UE, or
manage the use of the AI/ML models or AI/ML functionalities.

2. The user device, UE, of claim 1, wherein determining an applicability of an AI/ML model or AI/ML functionality comprise one or more of the following:
determining an AI/ML model or AI/ML functionality to be suitable,
determining an AI/ML model or AI/ML functionality to be used, or
determining an AI/ML model or AI/ML functionality to be cached

3. The user device, UE, of claim 1, wherein the certain information comprises assistance information, and the UE is to do one or more of the following:
receive from one or more entities of the wireless communication network the assistance information, the assistance information allowing the UE to determine one or more of the AI/ML models or AI/ML functionalities suitable and/or to be used and/or to be cached for a certain UE condition,
manage the use of the AI/ML models or AI/ML functionalities according to the received assistance information, or
evaluate the performance of AI/ML models and AI/ML functionalities based on the assistance information provided by one or more entities of the wireless communication network.

4. The user device, UE, of claim 3, wherein, responsive to receiving the assistance information, the UE is to determine the one or more of the AI/ML models or AI/ML functionalities suitable or to be used or to be cached for the certain UE condition.

5. The user device, UE, of claim 3, wherein the certain UE condition comprises one or more of the following:
a condition for a certain use case for which the UE is utilized, or
a condition for a certain scenario in which the UE is utilized, or
a condition at a certain site at which the UE is located, or
a certain gNB/NW configuration, or
a certain timestamp information, or
a certain frequency band, or
a certain UE internal capability, or
a certain UE configuration.

6. The user device, UE, of claim 3, wherein the certain UE condition comprises a current UE condition or an upcoming UE condition.

7. The user device, UE, of claim 3, wherein the assistance information includes
a signaling allowing the UE to determine the one or more AI/ML models or AI/ML functionalities to be applicable for the certain UE condition, or
information allowing the UE to determine the certain UE condition.

8. The user device, UE, of claim 7, wherein the signaling
explicitly indicates, e.g., by AI/ML model or AI/ML functionality identifiers, the one or more AI/ML models or AI/ML functionalities to be applicable for the certain UE condition, or
indicates the certain UE condition and the UE is to determine on its own the one or more AI/ML models or AI/ML functionalities to be applicable for the certain UE condition.

9. The user device, UE, of claim 7, wherein the signaling and/or the information allowing the UE to determine the certain UE condition comprises one or more of the following:
information about a position of the UE,
information about communication conditions,
one or more measurement results.

10. The user device, UE, of claim 9, wherein the information about a position of the UE comprises one or more of the following:
information about a geographical region or location where the UE is located, e.g.,
a communication range, like a distance from another entity of the wireless communication network device in terms of a minimum required communication range, MCR,
a location of the UE, e.g. GPS, GLONASS, BEIDOU, GALILEO,
information about the PLMN,
information about the paging area,
information about the tracking area,
information about the cell, beam,
information about neighboring Transmit/Receive Points (TRPs),
information about RAN-based Notification Area, RNA,
information about an AI zone or area,
information about a scenario in which the UE is employed, e.g.,
a scenario type, like urban, suburban, rural, indoors, outdoors, or
a cell type, like macro, micro, pico-cell, or
a UE density and distribution in the UE's environment.

11. The user device, UE, of claim 9, wherein the information about communication conditions comprises one or more of the following:
information about a configuration of a site at which the UE is located, e.g.,
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE and
a radio access network, RAN, of the wireless communication network, e.g., a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE and/or at a UE's communication partner, e.g.,
a beam direction, or
codebook information,
information about QoS conditions,
information about a cell load and/or a congestion.

12. The user device, UE, of claim 9, wherein the one or more measurement results comprise one or more of the following:
performance measurements in the uplink and/or in the downlink, e.g.,
throughput measurements,
latency measurements,
packet delay measurements, like a propagation delay, a queueing delay or an access delay,
error rates and packet loss measurements,
resource utilization measurements,
jitter measurements,
mobility measurements, e.g.,
a number of handovers,
a number of inter-or intra-gNB handovers,
a Doppler spread of a received signal,
an angular spread of a received signal.

13. The user device, UE, of claim 1, wherein the UE is to
receive a signaling from the wireless communication network which indicates whether the UE is to employ a model-based life cycle management, LCM, operation or functionality-based LCM operation, or
decide on its own whether to employ a model-based life cycle management, LCM, operation or functionality-based LCM operation

14. The user device, UE, of claim 1, wherein the UE is to receive the certain information
responsive to a request by the UE, or
in a control or data signal, e.g., aperiodically or periodically, from the wireless communication network.

15. The user device, UE, of claim 14, wherein a transfer of the certain information is requested by the UE or is triggered by the wireless communication network responsive to one or more criteria being fulfilled.

16. The user device, UE, of claim 15, wherein the one or more criteria comprise one or more of the following:
one or more thresholds are exceeded, like a throughput threshold, a latency thresholds, or packet loss threshold,
a change in the UE condition,
one or more events occurred, like a change in a site or scenario or a change in a channel condition,
detection of a further UE via a sidelink, e.g., by decoding sidelink discovery messages transmitted via PC5.

17. The user device, UE, of claim 1, wherein the one or more entities of the wireless communication network comprise one or more of the following:
one or more further UEs with which the UE is to communicate directly, e.g., via a sidelink or a PC5 interface, or
one or more RAN entities, like a gNB, of the wireless communication network.

18. The user device, UE, of claim 1, wherein the UE is to inform one or more further UEs, directly or via a RAN entity, about the one or more of the AI/ML models or AI/ML functionalities used by the UE, e.g., responsive to detecting a newly added further UE in the UE's environment or responsive to a request from a further UE.

19. The user device, UE, of claim 1, wherein the UE is a member of a UE group including the UE and at least one further UE, and wherein the similar or identical certain information is provided for to UE group members.

20. The user device, UE, of claim 1, wherein the certain information is associated with a validity, and wherein the validity is signaled explicitly, e.g., together with the certain information, or is derived implicitly, e.g., as a time duration, like a number of slots or subframes or frames or OFDM symbols, or a location, like a geographical location, for/at which the certain information may be used by the UE.

21. The user device, UE, of claim 1, wherein the UE is to receive the different certain information form a plurality of entities of the wireless communication network, and wherein the UE is to associate a priority to the different certain information and consider the one of highest priority valid.

22. The user device, UE, of claim 21, wherein the priority is determined based on one or more of the following:
a primary cell/cell group or secondary cell/cell group, e.g., prioritize the information from the primary cell/cell group,
an associated priority of a cell/gNB,
how recent the certain information is, e.g., value a last certain information more valid than an older one,
proximity and coverage area, e.g. UE may prioritize the information from the gNB that is closer in proximity or which provide better coverage,
roaming agreement, e.g. UE may prioritize information from gNB based on roaming agreements between operators or based on operator preferences,
a signal strength, RSSI, RSRP, SINR, SNR of a cell/cell group on which the certain information is received,
an explicitly signaled priority associated with the certain information,
a configured or preconfigured priority associated with the certain information.

23. The user device, UE, of claim 1, wherein, for managing the use of the AI/ML models or AI/ML functionalities according to the received assistance information, the UE is to perform one or more of the following:
in case the one or more AI/ML models or AI/ML functionalities determined to be applicable for the certain UE condition are not yet stored in the UE, downloading, retraining fully or partially if necessary, storing and activating the one or more AI/ML models or AI/ML functionalities to be applicable for the certain UE condition,
in case the one or more AI/ML models or AI/ML functionalities determined to be applicable for the certain UE condition are stored in the UE, retraining if necessary and/or activating the one or more AI/ML models or AI/ML functionalities to be applicable for the certain UE condition,
deactivating AI/ML models or AI/ML functionalities stored in the UE and determined not to be applicable for the certain UE condition,
deactivating all AI/ML models or AI/ML functionalities stored in the UE and using conventional non-AI based methods for performing the one or more tasks,
removing from a UE storage, partly or completely, AI/ML models or AI/ML functionalities stored in the UE and determined not to be applicable for the certain UE condition.

24. The user device, UE, of claim 23, wherein, in case the certain UE condition comprises an upcoming UE condition, downloading the one or more AI/ML models or AI/ML functionalities comprises
downloading one or more parts of the one or more AI/ML models or AI/ML functionalities at a time prior to the UE assuming the upcoming UE condition, and
downloading remaining parts of the one or more AI/ML models or AI/ML functionalities at a time the UE assumed the upcoming UE condition.

25. The user device, UE, of claim 23, wherein, in case the UE determines a specific UE condition, for which one or more specific AI/ML models or AI/ML functionalities were determined to be applicable, to reoccur after the certain UE condition with a probability exceeding a threshold, the UE is to
remove from the UE storage one part of the one or more specific AI/ML models or AI/ML functionalities, and
maintain in the UE storage the rest of the one or more specific AI/ML models or AI/ML functionalities.

26. The user device, UE, of claim 1, wherein the upcoming UE condition comprises a condition at a site at which the UE is located after a handover, HO, or after a conditional handover, CHO.

27. The user device, UE, of claim 1, wherein
the wireless communication network comprises one or more two-dimensional or three-dimensional zones,
the certain information identifies at least one predefined one of the zones, like an AI zone, and
when being within the predefined zone, the UE is to
determine one or more of the AI/ML models or AI/ML functionalities to be applicable while being in the predefined zone, and
manage the use of the AI/ML models or AI/ML functionalities according to the predefined zone.

28. The user device, UE, of claim 27, wherein the predefined zone comprises one or more of the following:
a single cell of the wireless communication network, a group of cells of the wireless communication network,
a zone associated with a particular scenario, e.g., one or more urban microcells, UMi, or one or more urban macrocells, UMa, or one or more rural microcells, RMi, or one or more rural macrocells RMa, or indoors,
a specific district, e.g., one or more cities, or one or more regions, or one or more countries, or one or more continents,
a certain area or volume described by its outer geometric shape.

29. The user device, UE, of claim 27, wherein each of the plurality of zones is identified by a unique identification.

30. The user device, UE, of claim 27, wherein two or more of the plurality of zones are grouped into a zone group, e.g., based on their similarities.

31. The user device, UE, of claim 27, wherein the predefined zone is valid for a certain time, e.g., for a rush-hour in a city, or a certain congestion scenario, e.g., for an air-space having a congestion kevel exceeding a threshold.

32. The user device, UE, of claim 27, wherein the predefined zone is defined by one or more of the following:
data of a global navigation satellite system, GNSS, e.g., GPS data, or GLONASS data, or Galileo data, or Beidou data,
a range of pathlosses between the UE and a radio access network, RAN, entity of the wireless communication network, like a gNB or a sidelink, SL, UE,
a communication range between the UE and a radio access network, RAN, entity of the wireless communication network, like a gNB or a sidelink, SL, UE,
a designated paging area data, including e.g., an area within which the UE is expected to be reachable by the network and can respond to the paging request,
a tracking area data, which consists e.g., of several cells grouped together for mobility management purposes,
a list or range of cell IDs, e.g. PCIs cellular or sidelink positioning techniques, e.g., by utilizing positioning reference symbols, like downlink positioning reference signals, DL-PRSs,
advanced MIMO techniques, e.g., by a correlation of beamformers.

33. The user device, UE, of claim 27, wherein the UE is to receive information allowing the UE to identify whether the UE is located in the predefined zone and the AI/ML models or AI/ML functionalities to be applicable by the UE in the predefined zone.

34. The user device, UE, of claim 33, wherein the information is included in one or more of the following:
a system information message received at the UE, like a system information block, SIB, or a master information block, MIB.
one or more aperiodic or periodic transmissions by the wireless communication network received at the UE,
one or more transmissions by the wireless communication network received at the UE in response to a request by the UE,
one or more transmissions by the wireless communication network received at the UE in response to a HO or a CHO,
a CHO configuration as a condition and the UE is to perform the CHO only if the UE comprises one or more AI/ML models or AI/ML functionalities to be applicable in a target zone,
a configuration or in a pre-configuration with which the UE is configured or preconfigured, e.g., by the wireless communication network or by a server connected to the wireless communication,
in a specification of the wireless communication,
a roaming configuration, e.g., if the UE is not connected to its home public land mobile network, PLMN.

35. The user device, UE, of claim 27, wherein, for managing the use of the AI/ML models or AI/ML functionalities according to the predefined zone, the UE is to perform before and/or after entering the predefined zone one or more of the following:
in case the one or more AI/ML models or AI/ML functionalities determined to be applicable for the predefined zone are not yet stored in the UE, downloading, retraining fully or partially if necessary, storing and activating the one or more AI/ML models or AI/ML functionalities to be applicable for the predefined zone,
in case the one or more AI/ML models or AI/ML functionalities determined to be applicable for the predefined zone are stored in the UE, retraining if necessary, activating the one or more AI/ML models or AI/ML functionalities to be applicable for the predefined zone,
deactivating AI/ML models or AI/ML functionalities stored in the UE and determined not to be applicable for the predefined zone,
deactivating all AI/ML models or AI/ML functionalities stored in the UE and using conventional non-AI based methods for performing the one or more tasks,
removing from a UE storage, partly or completely, AI/ML models or AI/ML functionalities stored in the UE and determined not to be applicable for the predefined zone.

36. The user device, UE, of claim 1, wherein the UE is to transmit a report about the management of the AI/ML models or AI/ML functionalities performed by the UE.

37. The user device, UE, of claim 1, wherein the UE is to prioritize the one or more of the AI/ML models or AI/ML functionalities to be applicable, and
use the one or more of the AI/ML models or AI/ML functionalities according to the prioritization.

38. The user device, UE, of claim 37, wherein the UE is to prioritize the one or more of the AI/ML models or AI/ML functionalities responsive to one or more of the following:
assistance information received from the wireless communication network,
one or more internal parameters of the UE,
one or more performance requirements to be fulfilled by the UE, e.g., achieving a low latency or obtaining an AI/ML model or AI/ML functionality performance exceeding a threshold,
one or more requirements and applicability conditions of the one or more AI/ML models or AI/ML functionalities.
one or more optimization reports from other UEs in the wireless communication network, priority list compiled by the UE or compiled and provided by the wireless communication network.

39. The user device, UE, of claim 38, wherein the one or more internal parameters comprise one or more of the following:
the UE has a sufficient battery life for executing one or more of the AI/ML models or AI/ML functionalities,
the UE has a sufficient storage capacity for executing one or more of the AI/ML models or AI/ML functionalities,
the UE has sufficient AI/ML computational capabilities for executing one or more of the AI/ML models or AI/ML functionalities,
the UE has no hardware limitation for executing one or more of the AI/ML models or AI/ML functionalities, e.g., the UE is able to process one or more LCM operations for a specific model or functionality,
the UE is not of a certain device type, e.g., a RedCap device or an IoT device which may not have the required hardware capabilities for executing one or more of the AI/ML models or AI/ML functionalities.
the UE has no vendor information prohibiting the execution of one or more of the AI/ML models or AI/ML functionalities, e.g., certain AI/ML models or AI/ML functionalities may be specific to a particular vendor.
the UE is subscribed to the use of the one or more AI/ML models or AI/ML functionalities, e.g., the UE's subscription support specific AI/ML models or AI/ML functionalities.

40. The user device, UE, of claim 1, wherein the one or more of tasks comprise one or more of the following:
AI/ML model based access to a RAN,
AI/ML model based network energy saving,
AI/ML model based scheduling optimizations
AI/ML model based network slicing management,
AI/ML model based load balancing,
an AI/ML model based mobility optimization,
AI/ML model based use cases, like
channel state information, CSI, feedback, like a CSI compression and/or a CSI prediction, or
beam management, or
positioning, like a direct AI/ML positioning (e.g., fingerprinting) and/or an AI/ML assisted positioning,
AI/ML model based mobility management, e.g., a handover, HO, prediction and/or conditional handover, CHO, prediction,
AI/ML model based modulation and coding scheme, MCS, selection,
AI/ML model based synchronization,
AI/ML model based encoding and/or decoding and/or precoding,
AI/ML model based modulation and/or demodulation,
AI/ML model based positioning or ranging,
AI/ML model based joint communication and sensing, JSAC,
AI/ML model based feedback calculation, e.g., CSI/CQI/PMI/RI feedback,
AI/ML model based interference management,
AI/ML model based quality of experience, QoE, and/or quality of service, QoS, predictions,
AI/ML model based network traffic forecasting.

41. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

42. A network entity for a wireless communication network,
wherein the network entity is to communicate with a user device, UE, of the wireless communication network, the UE using at least one Artificial Intelligence/Machine Learning model, AI/ML model, or at least one AI/ML functionality for performing one or more tasks, and
wherein the network entity is to provide to the UE assistance information allowing the UE to determine one or more of the AI/ML models or AI/ML functionalities to be applicable by the UE, and/or to manage the use of the AI/ML models or AI/ML functionalities.

43. The network entity of claim 42, wherein the UE comprises a user device, UE, of claim 1.

44. The network entity of claim 42, wherein the assistance information includes
a signaling allowing the UE to determine the one or more AI/ML models or AI/ML functionalities to be applicable for a certain UE condition, or
information allowing the UE to determine a certain UE condition

45. The network entity of claim 44, wherein the signaling
explicitly indicates, e.g., by AI/ML model or functionality identifiers, the one or more AI/ML models or AI/ML functionalities to be applicable by the UE for the certain UE condition, or
indicates the certain UE condition on the basis of which the UE is to determine on its own the one or more AI/ML models or AI/ML functionalities to be applicable by the UE for the certain UE condition.

46. The network entity of claim 44, wherein the information for determining the signaling and/or the information allowing the UE to determine the certain UE condition comprises one or more of the following:
information about a position of the UE,
information about communication conditions,
one or more measurement results.

47. The network entity of claim 46, wherein the information about a position of the UE comprises one or more of the following:
information about a geographical region or location where the UE is located, e.g.,
a communication range, like a distance from another entity of the wireless communication network device in terms of a minimum required communication range, MCR,
a location of the UE, e.g. GPS, GLONASS, BEIDOU, GALILEO,
information about the home PLMN,
information about the paging area,
information about the cell, beam,
information about RAN-based Notification Area, RNA,
information about neighboring Transmit/Receive Points (TRPs),
information about an AI zone or area,
information about a scenario in which the UE is employed, e.g.,
a scenario type, like urban, suburban, rural, indoors, outdoors, or
a cell type, like macro, micro, pico-cell, or
a UE density and distribution in the UE's environment.

48. The network entity of claim 46, wherein the information about communication conditions comprises one or more of the following:
information about a configuration of a site at which the UE is located, e.g.,
a bandwidth or bandwidth part used for the communication, or
a carrier frequency or carrier selection in case of scenarios involving carrier aggregation, CA, or
a gNB beam codebook, or
a gNB virtualization configuration, or
a transmission power,
information about one or more channel conditions of a radio channel between the UE and a radio access network, RAN, of the wireless communication network, e.g.,
a line-of-sight, LOS, or non-LOS, NLOS, or
one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
one or more CQI and CSI measurements, or
a pathloss,
information about beamforming performed at the UE and/or at a UE's communication partner, e.g.,
a beam direction, or
codebook information,
information about QoS conditions,
information about a cell load and/or a congestion.

49. The network entity of claim 46, wherein the one or more measurement results comprise one or more of the following:
performance measurements in the uplink and/or in the downlink, e.g.,
throughput measurements,
latency measurements,
packet delay measurements, like a propagation delay, a queueing delay or an access delay,
error rates and packet loss measurements,
resource utilization measurements,
jitter measurements,
mobility measurements, e.g.,
a number of handovers,
a number of inter-or intra-gNB handovers,
a Doppler spread of a received signal,
an angular spread of a received signal.

50. The network entity of claim 42, wherein the network entity is to send to the UE a signaling which indicates whether the UE is to employ a model-based life cycle management, LCM, operation or functionality-based LCM operation.

51. The network entity of claim 42, wherein the network entity is to provide the assistance information
responsive to a request from the UE, or
in a control or data signal, e.g., aperiodically or periodically.

52. The network entity of claim 51, wherein a transfer of the assistance information is triggered by the wireless communication network responsive to one or more criteria being fulfilled, wherein the to one or more criteria comprise, e.g., one or more of the following:
one or more thresholds are exceeded, like a throughput threshold, a latency thresholds, or packet loss threshold,
a change in the UE condition,
one or more events occurred, like a change in a site or scenario or a change in a channel condition,
detection of a further UE via a sidelink, e.g., by decoding sidelink discovery messages transmitted via PC5.

53. The network entity of claim 42, wherein the network entity is provide similar or identical assistance information a UE group including the UE and at least one further UE.

54. The network entity of claim 42, wherein the certain UE condition comprises one of the following:
a condition for a certain use case for which the UE is utilized, or
a condition for a certain scenario in which the UE is utilized, or
a condition at a certain site at which the UE is located, or
a certain gNB/NW configuration, or
a certain timestamp information, or
a certain frequency band, or
a certain UE internal capability, or
a certain UE configuration.

55. The network entity of claim 42, wherein the certain UE condition comprises a current UE condition or an upcoming UE condition.

56. The network entity of claim 42, wherein the network entity is to
gather optimization reports from one or more further UEs for particular AI/ML models or AI/ML functionalities for different configurations, sites or scenarios, wherein the optimization report comprises supplementary information that represents a current condition of the further UE, like a performance evaluation of one or more AI/ML models or AI/ML functionalities employed by the further UE, and extract from the one or more optimization reports information to be provided at least as part of the assistance information to the UE.

57. The network entity of claim 42, wherein the network entity comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

58. A wireless communication network, like a 3rd Generation Partnership Project, 3GPP, system, comprising a one or more user devices, UEs, of claim 1 and/or one or more network entities of claim 42.

59. A method for operating a user device, UE, for a wireless communication network, wherein the UE is to use at least one Artificial Intelligence/Machine Learning model, AI/ML model, or at least one AI/ML functionality for performing one or more tasks, the methods comprising:
on the basis of certain information, doing one more of the following
determining one or more of the AI/ML models or AI/ML functionalities to be applicable by the UE, or
managing the use of the AI/ML models or AI/ML functionalities.

60. A method for operating a network entity for a wireless communication network, wherein the network entity is to communicate with a user device, UE, of the wireless communication network, the UE using at least one Artificial Intelligence/Machine Learning model, AI/ML model, or at least one AI/ML functionality for performing one or more tasks, the method comprising:
providing to the UE assistance information allowing the UE to determine one or more of the AI/ML models or AI/ML functionalities to be applicable by the UE, and/or to manage the use of the AI/ML models or AI/ML functionalities.

61. A non-transitory digital storage medium having a computer program stored thereon to perform the method of claim 58 or 59 when said computer program is run by a computer.
